(19) United States
(12) Patent Application Publication
(10) Pub. No.: US 2022/0131470 A1
(43) Pub. Date: Apr. 28, 2022

(54) CONTROL OF POWER CONVERTERS

(71) Applicant: FINsix Corporation, Menlo Park, CA (US)

(72) Inventors: Anthony Sagneri, Palo Alto, CA (US); Victor Sinow, Oakland, CA (US); Kai Li, Fremont, CA (US)

(21) Appl. No.: 17/339,773

(22) Filed: Jun. 4, 2021

Related U.S. Application Data
(63) Continuation of application No. 16/270,818, filed on Feb. 8, 2019, now abandoned.
Application No. 16/270,818 is a continuation of application No. PCT/US2017/046273, filed on Aug. 10, 2017.
(60) Provisional application No. 62/373,605, filed on Aug. 11, 2016.

(51) Int. Cl. H02M 3/335; H02M 3/337; G05F 1/00; H05B 45/327; H05B 45/335; H05B 45/3725; H05B 45/382; H05B 45/39; H02M 1/08

(52) U.S. Cl. CPC H02M 3/33569; H02M 3/337; G05F 1/00; H05B 45/327; H05B 45/335; H05B 45/375; H05B 45/382; H05B 45/39; H02M 1/083; Y02B 70/10; H05B 45/3725

(57) ABSTRACT

A power module includes a power converter having a controller configured to control the power converter. The controller is configured to control the power converter using feedback for a first load on the power converter, and to allow the power converter to operate without controlling the power converter using the feedback for second load on the power converter higher than the first load.

### CROSS-REFERENCE TO RELATED APPLICATIONS

This application is a continuation of U.S. patent application Ser. No. 16/270,818, titled “CONTROL OF POWER CONVERTERS,” filed Feb. 8, 2019, which is a continuation of International Patent Application No. PCT/US2017/046273, titled “CONTROL OF POWER CONVERTERS,” filed Aug. 10, 2017, which claims priority to U.S. provisional application Ser. No. 62/373,605, titled “CONTROL OF POWER CONVERTERS,” filed Aug. 11, 2016, each of which is incorporated herein by reference in its entirety.

### DISCUSSION OF RELATED ART

Power electronics refers to electronics for the processing of electric power. A power converter is a power electronics circuit that converts power from one form to another. Common examples of power converters include AC-DC converters, DC-AC converters, DC-DC converters and AC-AC converters. Power converters may change AC power to DC power, DC power to AC power, and/or may process power to produce changes in the magnitude of voltage and/or current, for example.

### SUMMARY

A power module, comprising: a power converter having a controller configured to control the power converter, the controller being configured to control the power converter using feedback for a first load on the power converter, and to allow the power converter to operate without controlling the power converter using the feedback for second load on the power converter higher than the first load.

A method of operating a power converter, comprising: controlling the power converter using feedback for a first load on the power converter; allowing the power converter to operate without controlling the power converter using the feedback for second load on the power converter higher than the first load.

A power module, comprising: a power converter having a controller configured to control the power converter, the controller being configured to control the power converter using feedback for a first load on the power converter, and to allow the power converter to operate in an open-loop configuration for a second load on the power converter higher than the first load.

A method of operating a power converter, comprising: controlling the power converter using feedback for a first load on the power converter; allowing the power converter to operate in an open-loop configuration for a second load on the power converter higher than the first load.

A power module, comprising: a power converter having a controller configured to control the power converter, the controller being configured to control the power converter using feedback when an output of the power converter is within a first range, and to allow the power converter to operate without controlling the power converter using the feedback when the output of the power converter is below the first range.

A method of operating a power converter, comprising: controlling the power converter using feedback when an output of the power converter is within a first range; and allowing the power converter to operate without controlling the power converter using the feedback when the output of the power converter is below the first range.

A power module, comprising: a power converter having a controller configured to control the power converter, the controller being configured to control the power converter using feedback when an output of the power converter is within a first range, and to allow the power converter to operate in an open-loop configuration for a second load on the power converter when the output of the power converter is below the first range.

A method of operating a power converter, comprising: controlling the power converter using feedback when an output of the power converter is within a first range; and allowing the power converter to operate in an open-loop configuration for a second load on the power converter when the output of the power converter is below the first range.

The power converter may be a resonant power converter.

The power converter may operate with feedforward control when the output of the power converter is within or below the first range.

The control with feedback may be performed using hysteresis.

The with feedback using hysteresis may include varying sub-modulation based on the feedback.

The sub-modulation based on the feedback may comprise turning off the power converter when an output of the power converter reaches an upper boundary of a hysteresis band and turning on the power converter when the output of the power converter reaches a lower boundary of the hysteresis band.

The converter may be controlled to stay on when the output of the power converter is below the lower boundary of the hysteresis band.

A power module, comprising: a power converter having a controller configured to control the power converter, the controller being configured to i) when an output of the power converter is within a first range, control the power converter using feedback to sub-modulate the power converter with hysteresis, such that the power converter is turned off when an output of the power converter reaches an upper edge of a hysteresis band and the power converter is turned on when the output reaches a lower edge of the hysteresis band; and ii) allow the power converter to operate without the feedback when the output falls below the lower edge of the hysteresis band.

A power module, comprising: a power converter having a controller configured to control the power converter, the controller being configured to i) when an output of the power converter is within a first range, control the power converter using feedback to sub-modulate the power converter with hysteresis, such that the power converter is turned off when an output of the power converter reaches an upper edge of a hysteresis band and the power converter is turned on when the output reaches a lower edge of the hysteresis band; and ii) allow the power converter to operate in an open-loop configuration when the output falls below the lower edge of the hysteresis band.

ii) may include controlling the power converter using feedforward control.

i) may include controlling the power converter using feedforward control.

i) may be performed for loads exceeding a first threshold level

ii) may be performed for loads below a second threshold level.

A power module, comprising: a power converter having: a sensor to sense an input of the power converter; and control circuitry configured to: detect an extent of variation of the input, a frequency of the input, and a phase of the input; generate a model of the input based upon the extent of variation of the input, a frequency of the input, a phase of the input and an expected shape of the input; and calculate a compensated value of the input using the model of the input at a phase selected to compensate for a phase delay of the sensor.

The input may comprise input voltage.

The control circuitry may be configured to detect an extent of variation of the input by measuring a minimum of the input and a maximum of the input.

The power module may further comprise a memory storing the expected shape of the input.

The expected shape of the input may comprise a portion of a sinusoid during a first time period and a line during a second time period.

The power module may further comprise a memory storing a model or inverse model of the sensor.

The control circuitry may be configured to use the model or inverse model to select the phase to phase to compensate for the phase delay of the sensor.

The control circuitry may be further configured to control the power converter using the compensated value of the input.

The control circuitry may be further configured to control the power converter by setting a switching frequency of the power converter based on the compensated value of the input.

The power converter may be a resonant power converter.

A method, comprising: sensing an input of the power converter using a sensor; detecting an extent of variation of the input, a frequency of the input, and a phase of the input; generating a model of the input based upon the extent of variation of the input, a frequency of the input, a phase of the input and an expected shape of the input; and calculating a compensated value of the input using the model of the input at a phase selected to compensate for a phase delay of the sensor.

A power module comprising: a power converter; a sensor to sense an input of the power converter; and control circuitry configured to calculate a compensated value of the input to compensate for a phase delay of the sensor, and control the power converter using the compensated value of the input.

The power converter may be a resonant power converter.

The control circuitry may be configured to control the power converter by setting a switching frequency of the power converter using the compensated value of the input.

A power module comprising: a power converter; a sensor to sense an input of a power converter; and control circuitry configured to calculate input power to the power converter based upon an extent of variation of the input.

The control circuitry may be configured to calculate the input power using a minimum value of the input and a maximum value of the input.

The control circuitry may be configured to control the power converter using the calculated input power.

A method, comprising: sensing an input of a power converter; and calculating input power to the power converter based upon an extent of variation of the input.

A non-transitory computer readable storage medium having stored thereon instructions which, when executed by a microprocessor, perform any of the techniques described herein.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques described herein.

FIG. 1 shows the efficiency η of a resonant power converter versus switching frequency.

FIG. 2 shows a timing diagram illustrating sub-modulation.

FIGS. 3A-3I show block diagrams of resonant power converters controlled by a variety of control techniques using switching frequency modulation and sub-modulation.

FIG. 4 shows a circuit diagram of an LLC converter, according to some embodiments.

FIG. 5 illustrates hysteretic control of the output of a resonant power converter.

FIG. 6 shows examples of curves mapping input voltage to switching frequency for different output power levels.

FIGS. 7A-7D illustrate block diagrams and waveforms of a buck converter controlled with duty ratio D modulation and sub-modulation duty ratio M.

FIG. 8 shows a diagram of a resonant converter.

FIG. 9 shows the resonant converter can be modeled as a Thevenin equivalent network.

FIG. 10 illustrate the output voltage produced according to a technique of hysteretic sub-modulation, in which the power converter is turned on or off to keep the output within a hysteresis band.

FIG. 11 shows a flowchart illustrating control of a power converter in two different control modes: M1 and M2.

FIG. 12 shows an exemplary waveform of the output voltage of the power converter vs. time.

FIG. 13 shows which control mode applies in different regimes of power delivery.

FIG. 14 shows a model of an AC mains connected power supply.

FIG. 15 shows a diagram of a primary rectifier connected to the AC line, which provides a voltage VAC to the primary rectifier.

FIG. 16 shows the voltage across the capacitor CF and a rectified version of voltage VAC.

FIG. 17 shows a Thevenin equivalent network particularly suited to resonant converters, that treats the power converter as a source of a fixed amplitude, Vs, in series with an impedance, Zs.

FIG. 18 shows an exemplary waveform for V_{IN}.

FIG. 19 shows a block diagram of a technique for compensating for the transfer function of the sensor in the feed-forward path.

FIG. 20 is a block diagram of an illustrative computing device.

### DETAILED DESCRIPTION

Due to conservation of energy, the power at the output port of a power converter is less than or equal to the power at the input port. Real-world power converters have losses, including but not limited to conduction losses, switching losses, losses in magnetic components, etc., which convert a portion of the input power into heat. The efficiency of a power converter is the ratio of its output power to its input power. Due to power losses, the efficiency of a real power converter is less than 100%. It would be desirable to improve the efficiency of power converters to reduce the amount of power lost as heat, which also has the benefit of limiting the rise in temperature of the power converter. Power converters that are less efficient may need to be designed to dissipate heat for reasons such as improving the lifetime of components and staying within regulatory limits for consumer devices, by way of example. Active and/or passive cooling may need to be used to keep the temperature of a power converter within acceptable limits. Improving the efficiency of a power converter would reduce the need for thermal management.

There is also a desire to reduce the size of power converters for many applications. For example, in consumer applications, it would be desirable to reduce the size of power converters to reduce the size of power adapters or power modules for consumer electronic devices, particularly those having significant power requirements. Although small power adapters are available in the marketplace for charging small consumer electronic devices such as cellular telephones, such devices have limited output power.

The size of passive components within a switch-mode power supply (SMPS) can be reduced by increasing the switching frequency. Increasing the switching frequency increases the rate at which the switches of the power converter are turned on and off, which increases switching power loss due to the energy dissipated each time the switches of the power converter are turned on or off.

In order to achieve the highest possible efficiency in a SMPS, resonant power converters of various topologies are often used. These topologies allow for improved efficiency primarily through the reduction of switching losses in the power semiconductors. Switching loss arises from two sources—overlap loss, occurring when the voltage and current at the port of a power semiconductor are simultaneously non-zero, and capacitive discharge loss, arising when energy stored in transistor or diode parasitic capacitances are dissipated as a result of commutating the device.

Overlap loss is reduced or mitigated by using resonant circuits to achieve nearly orthogonal voltage and current at power semiconductor device ports during commutation. This is typically accomplished by arranging the SMPS network with complementary reactance, which allows the state of the power semiconductor parasitic capacitances to be modified before commutation. For instance, in converters that utilize zero-voltage switching (ZVS) this allows the device voltage to ring to near-zero before the channel begins to conduct. Additionally, since the device voltage is zero before turn-on, capacitive-discharge losses are also mitigated. In zero-current switching (ZCS) the current is brought to zero before the device is commutated. While this mitigates overlap loss, it may not address capacitive discharge loss.

While resonant power converters can dramatically reduce frequency-dependent switching losses, this is accomplished at the expense of circulating currents that arise from the resonant action. These circulating currents cause loss in the form of increased (root-mean-square) conduction currents in the power devices and dissipation in the various reactive elements themselves as energy is alternately cycled among them. The net result is that many resonant converters are only efficient in a relatively narrow operating regime as compared to traditional hard-switching converter topologies.

One way operating regime restrictions manifest in resonant converters occurs when frequency modulation is used to affect control. In this approach, the resonant power converter is designed to deliver maximum power near some frequency, and power is reduced as the converter frequency is moved elsewhere. Such converters include the series resonant converter, the parallel resonant converter, and the LLC, among a host of others. When the converter is operating near resonance and delivering maximum power, much of the current circulating in the network carries real power from the source to the load. However, as the frequency is slewed away from the maximum power point, (e.g., to adjust to a change in load), the circulating currents arising from commutation of the switches begin to dominate. In the extreme case, almost all the energy circulating in the network can be due to commutation of the switches. Since little or no power is delivered to the load, this operating point is very inefficient.

Reduced efficiency arises if input voltage or output voltage changes need to be accommodated, as this requires a change in switching frequency to maintain the desired output. For instance, in an LLC converter operated on the inductive side of its transfer function, output voltage can be regulated in the face of load by slewing the switching frequency. If the load increases, the frequency is lowered to keep the output voltage from drooping. If the load decreases, the frequency is raised to prevent the output voltage from rising.

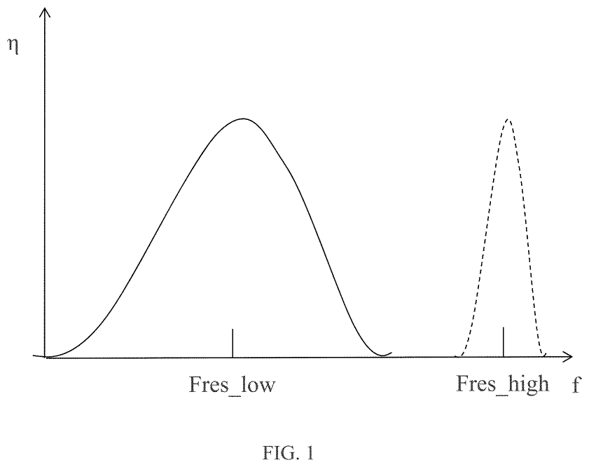

The efficiency of a resonant power converter changes significantly when the switching frequency is changed. As illustrated in FIG. 1, resonant power converters are most efficient when operated with a switching frequency within a range of frequencies near the resonant frequency. FIG. 1 shows the efficiency η of a resonant power converter versus switching frequency. The solid curve shows the efficiency for a power converter having a relatively low resonant frequency Fres_low, and the dashed curve shows the efficiency for a power converter having a relatively high resonant frequency Fres_high. As illustrated in FIG. 1, the higher the resonant frequency is the more the range of switching frequencies for which the converter can operate efficiently shrinks. This is an obstacle for producing a high-frequency resonant power converter that is capable of operating efficiently across a wide range of inputs and/or outputs. In a conventional resonant converter controlled by switching frequency modulation, the switching frequency may need to be changed across a wide range to control the power converter across a wide range of inputs or outputs. If a resonant power converter is operated near extrema of its input and/or output range the efficiency is reduced significantly. Although a high-frequency resonant power converter may be designed to operate efficiently in a narrow range of switching frequencies, it will become less efficient as the input and/or output varies, due to the change in switching frequency needed to accommodate these inputs and/or outputs. To improve efficiency, it would be desirable to operate a resonant power converter over a narrower range of switching frequencies at which the converter is most efficient.

The extrema of the frequency range are determined by the desired load range and the design of the resonant tank circuit. As load range is increased, the gap between peak efficiency and minimum efficiency across the load range typically increases, as well. This undesirable characteristic arises partially because increased load range is typically realized by increased frequency range. The challenge compounds if the input voltage is allowed to vary. At a given frequency the output power will rise with input voltage, thus introducing input voltage variation which further increases the required frequency range, and the result is usually undesirably low efficiency over some area of the operating regime.

It has been recognized and appreciated that these challenges can be overcome by introducing a second control parameter that provides a second degree of freedom to control the power converter. In a resonant power converter, the second control parameter can be used to compress the switching frequency range over a given operating regime of inputs and outputs, resulting in a smaller spread between peak and minimum efficiency. For instance, by introducing on-off modulation, the average output power delivered to the load and the instantaneous power through the power converter can be different. This allows flexibility in choosing the operating point of the converter, which can yield any number of benefits (e.g. increased efficiency, lower device stresses, reduced electromagnetic emissions).

In some embodiments, a resonant power converter may be sub-modulated at a sub-modulation frequency lower than the switching frequency of the resonant power converter. To sub-modulate a power converter, the power converter is switched on an off at the sub-modulation frequency. As an example, if the resonant power converter has a switching frequency in the MHz range, the resonant converter may be turned on and off at a frequency in the kHz range. However, this is merely by way of example, and any suitable sub-modulation frequency may be selected.

By way of example, consider an LLC converter to be operated over a 10:1 load range and a 3:1 input voltage range. If switching frequency is the only control handle, the difference between maximum and minimum switching frequency would be quite large. The resulting converter efficiency may be unacceptably low at some points in the desired operating regime. If on-off modulation is introduced to regulate the output power, then frequency modulation may be employed to accommodate only the input voltage range. One way to accomplish this would be to select the operating frequency as a function of input voltage such that the instantaneous power of the LLC power stage is held approximately constant. Then, as the load demands more or less power, the sub-modulation duty ratio is varied while the frequency remains constant for any given input voltage.

The resulting compression of frequency range allows the efficiency spread to be reduced over the operating regime of inputs and outputs. In the case of a constantly varying input, such as the rectified AC utility line voltage, this technique produces an overall increase in converter efficiency over the desired load range.

It should be recognized that the roles of the two control handles (switching frequency, f, and sub-modulation duty ratio, M) may be interchanged, or otherwise combined in any fashion to achieve the desired goal, whether efficiency, reduced switch stress, reduced EMI, or a combination of these. For example, the on-off modulation may be used to accommodate the input line variation and frequency modulation may be used to accommodate load changes. The frequency to input voltage map vary depending on load.

Controlling a second degree of freedom of the power converter is particularly valuable if the desire is to increase switching frequency dramatically, as illustrated by FIG. 1. As frequency increases, the resonant circulating currents increase accordingly. This makes the inefficiency associated with moving away from the optimal operating point manifest more rapidly because the resonant commutation currents make up a larger portion of the total current in the converter and they do not necessarily scale with load.

In conventional AC/DC power modules that are designed to convert power from the mains into a DC voltage, power factor correction circuitry is provided on the front-end of the converter. Power factor correction circuitry is required on the front end in some applications above a certain wattage to preserve the power quality on the mains line. Such power factor correction circuitry includes one or more passive components, such as a capacitor, that has the effect of stabilizing the input voltage to the power converter. As a result, the power converter does not need to accommodate as large of an input range, and accordingly may be designed to operate more efficiently.

However, in some applications power factor correction circuitry may be omitted where it is not required. For example, power factor correction circuitry may not be required for switch mode power supplies having wattages below a certain value. A cost savings can be achieved by omitting the power factor correction circuitry. However, doing so may make the input voltage to the converter less stable, and it may need to operate over a wider range of inputs. Accordingly, the technique of introducing a second degree of freedom may be particularly valuable in applications where power factor correction circuitry is omitted, as it can allow accommodating the wider range of input voltages produced by omitting power factor correction circuitry.

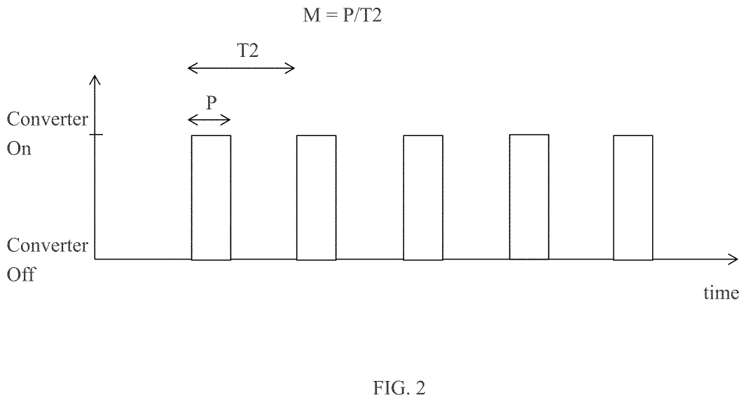

FIG. 2 shows a timing diagram illustrating sub-modulation. The power converter is turned on for a time period P and then turned off for a period of time. In this example, the sub-modulation is periodic with a sub-modulation period T2 and sub-modulation frequency of 1/T2. The sub-modulation duty ratio M is the fraction of the sub-modulation period for which the power converter is turned on, and is expressed by M=P/T2. Increasing the sub-modulation duty ratio increases the output of the power converter for a constant input. Conversely, decreasing the sub-modulation duty ratio decreases the output of the power converter for a constant input. Varying the sub-modulation duty ratio provides an additional degree of freedom of control that can accommodate a wide range of inputs and outputs while maintaining switching frequency within a narrow range. In some embodiments, the sub-modulation frequency may be between 0.01% and 10% of the switching frequency. In some embodiments, the sub-modulation frequency may be between 20 kHz and 300 MHz.

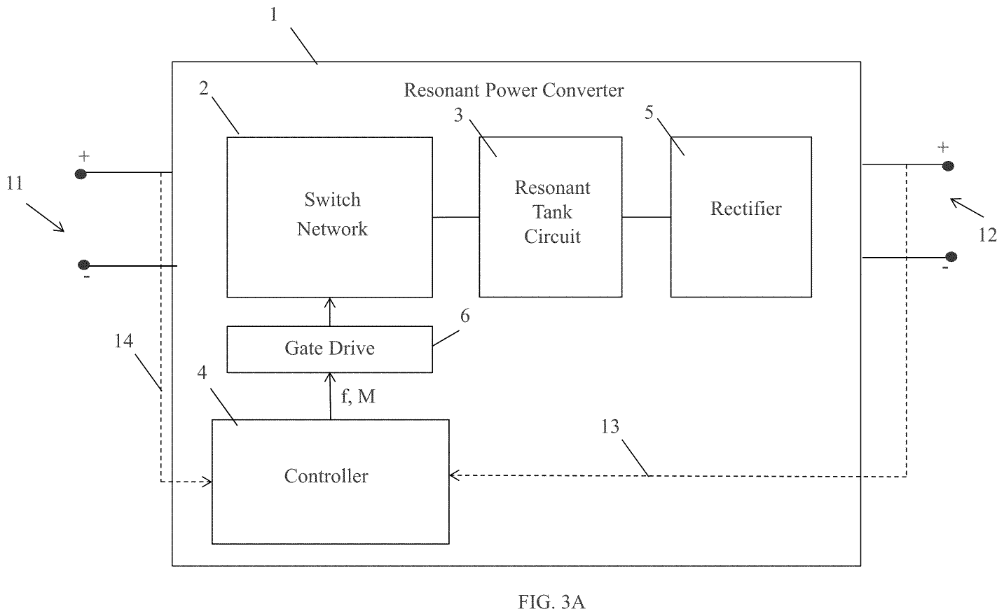

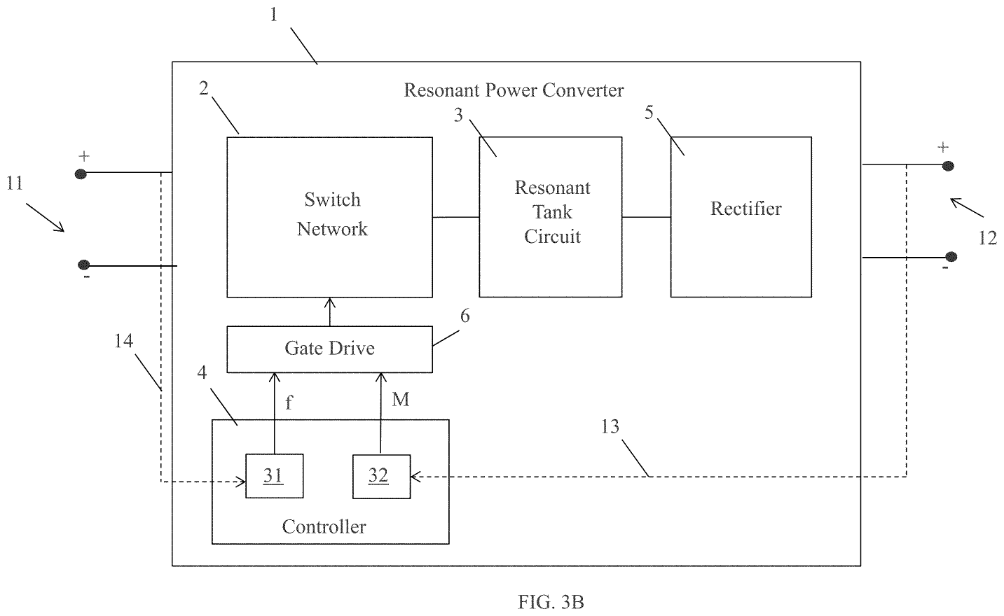

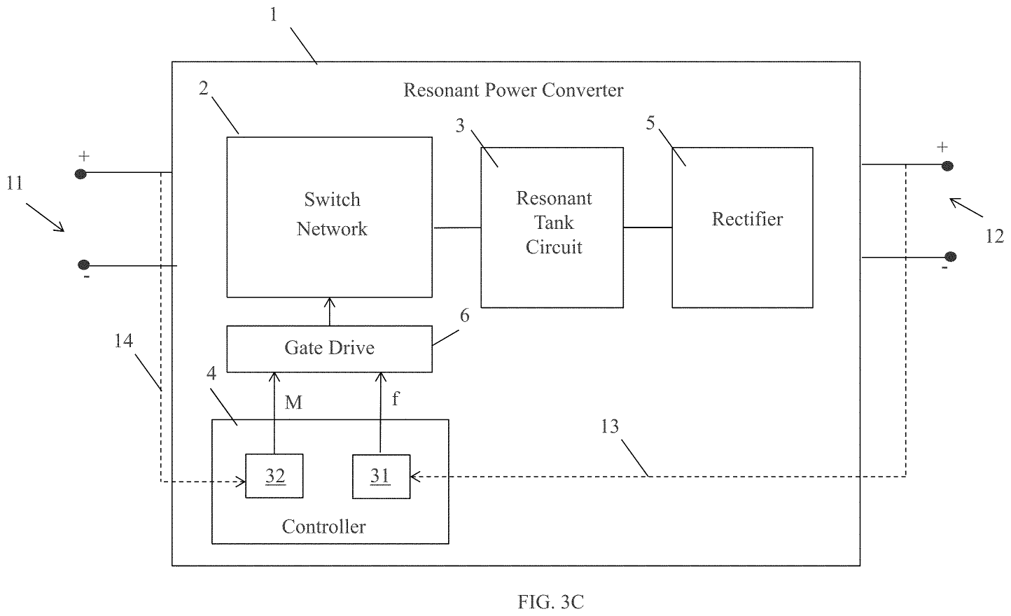

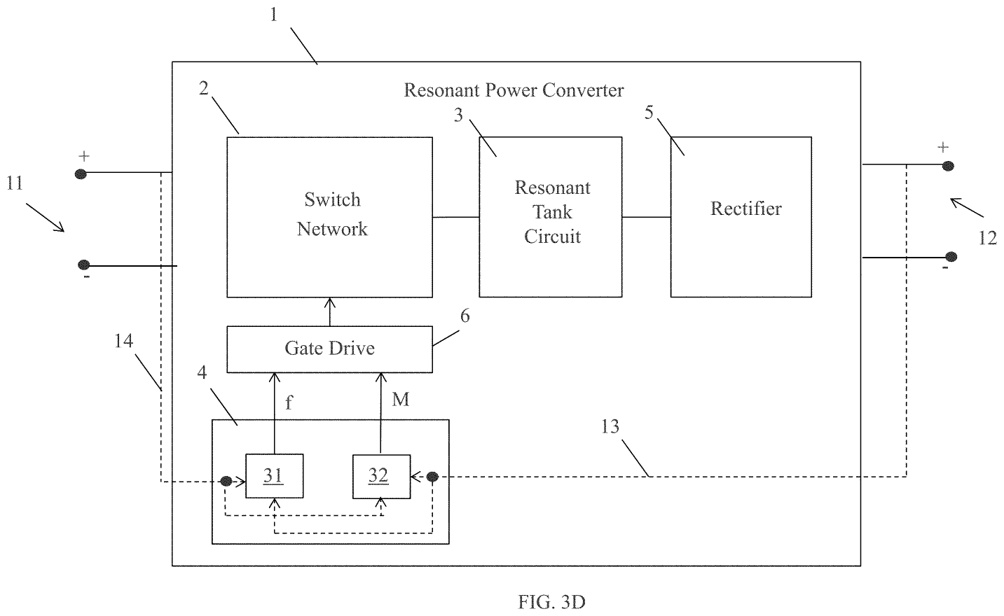

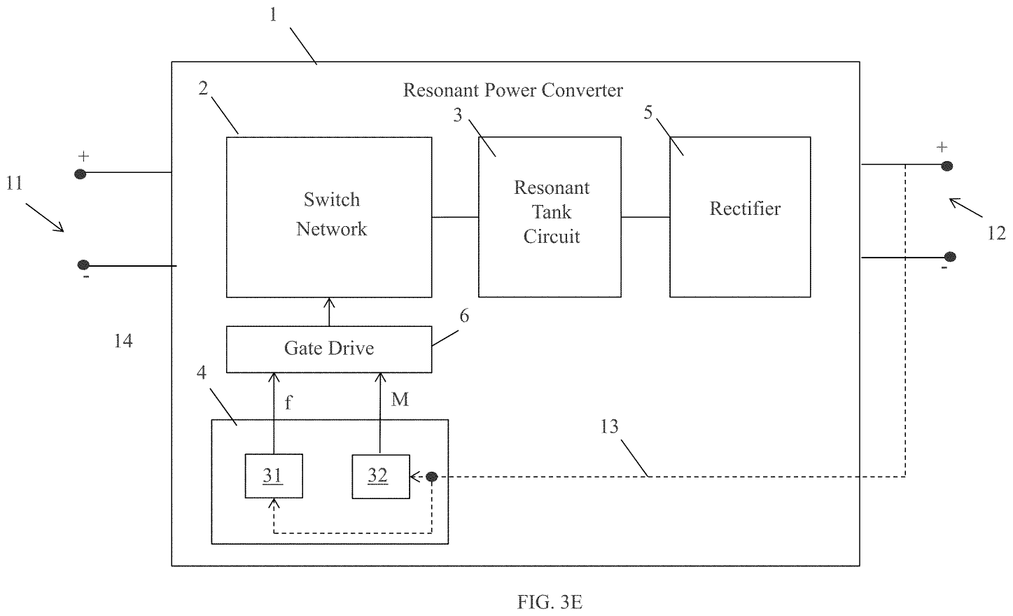

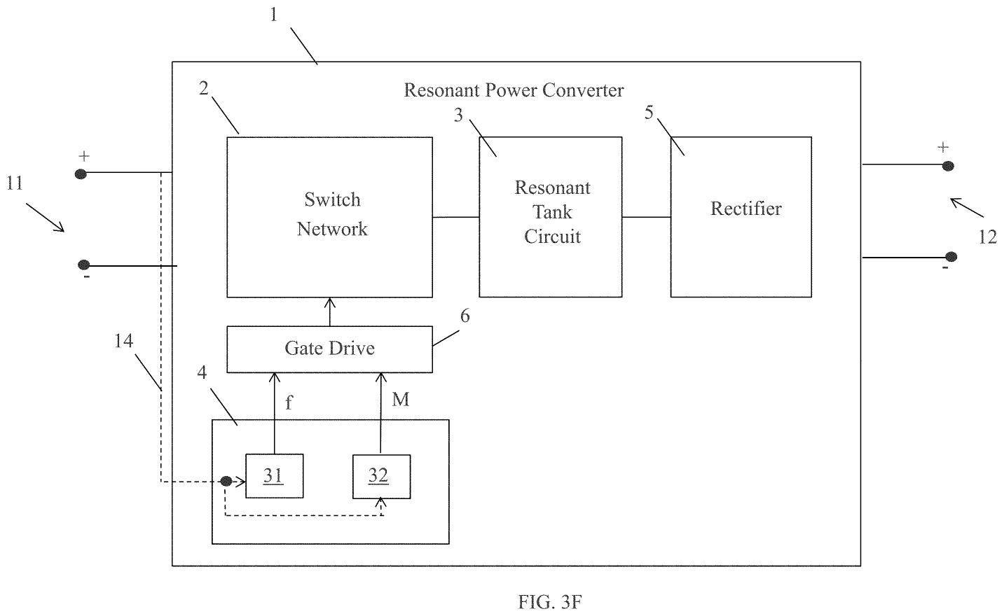

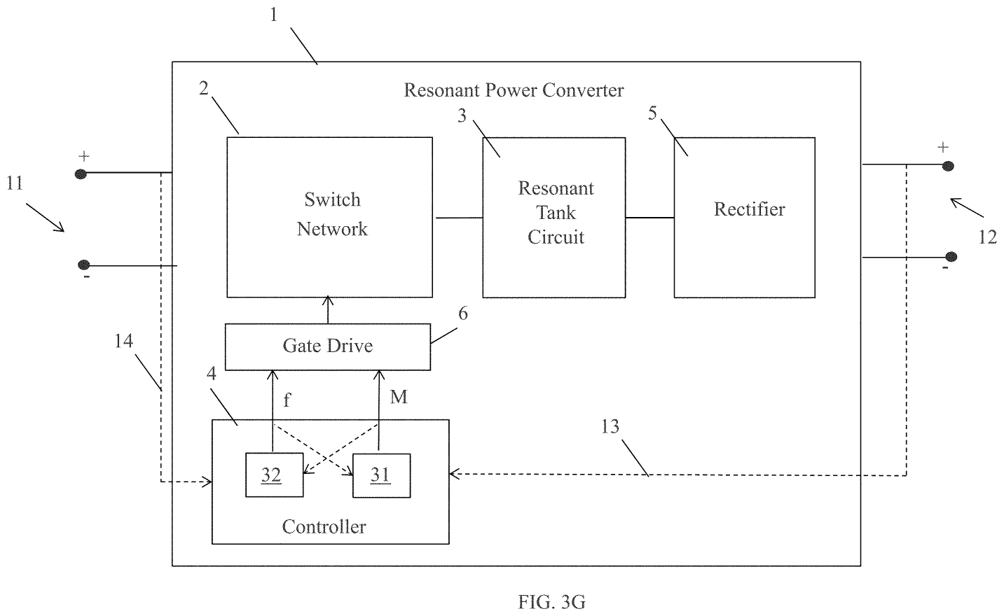

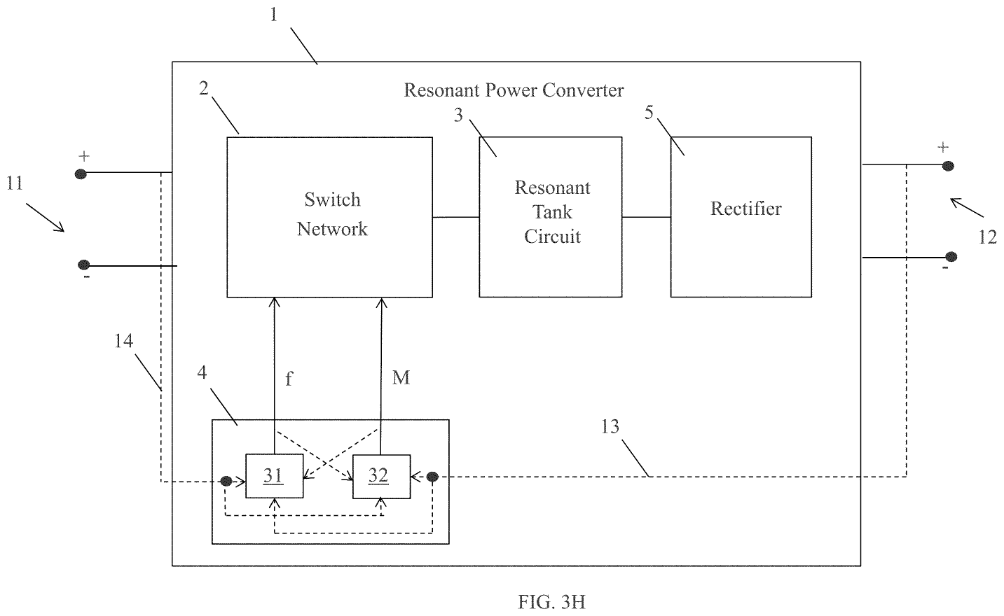

FIG. 3A shows a block diagram of a resonant power converter 1, according to some embodiments. Resonant power converter 1 includes a switch network 2 connected to a resonant tank circuit 3. The resonant power converter has an input port 11 and an output port 12, each with high-side and low-side terminals (+/−). In some embodiments, the resonant power converter 1 may be an AC/DC converter and may include a rectifier 5 to rectify the output of the resonant tank circuit 3. In some embodiments, the resonant power converter 1 may produce a DC output voltage at output port 12. Input port 11 may receive a rectified input signal from an AC line, which may be a voltage that varies across a wide range. In some embodiments, the resonant power converter 1 may have a switching frequency of greater than 100 kHz, such as 500 kHz or greater, 1 MHz or greater, 5 MHz or greater, or even higher. The switching frequency may be less than 300 MHz.

The resonant tank circuit 3 may include any suitable combination of at least one inductive element and at least one capacitive element. For example, the resonant tank circuit 3 may include an inductive element and a capacitive element in series (e.g., for a series resonant converter), an inductive element and a capacitive element in parallel (e.g., for a parallel resonant converter), two inductive elements and a capacitive element (e.g., for an LLC converter) or two capacitive elements and an inductive element (e.g., for a LCC converter), by way of example and not limitation.

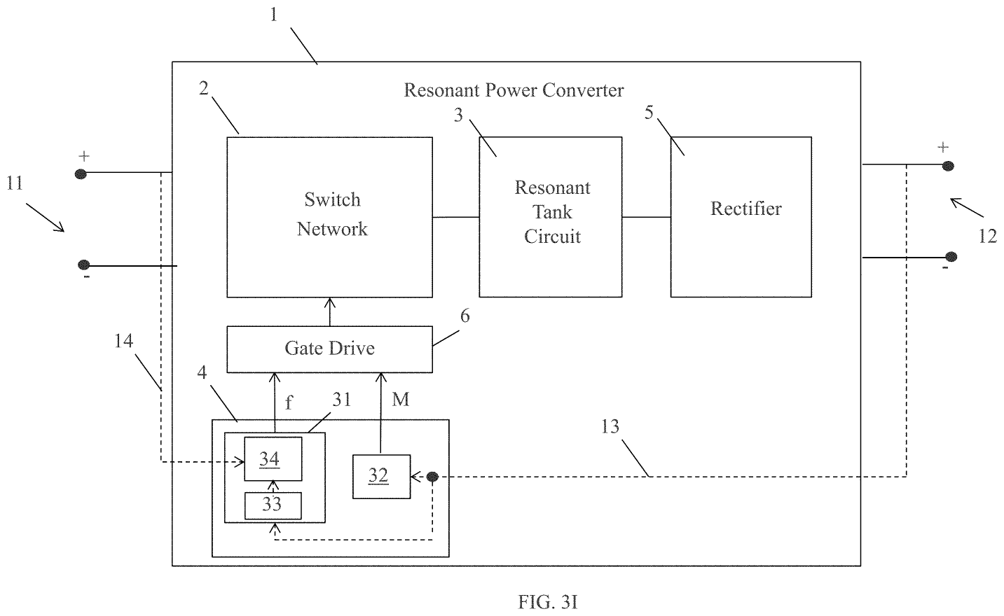

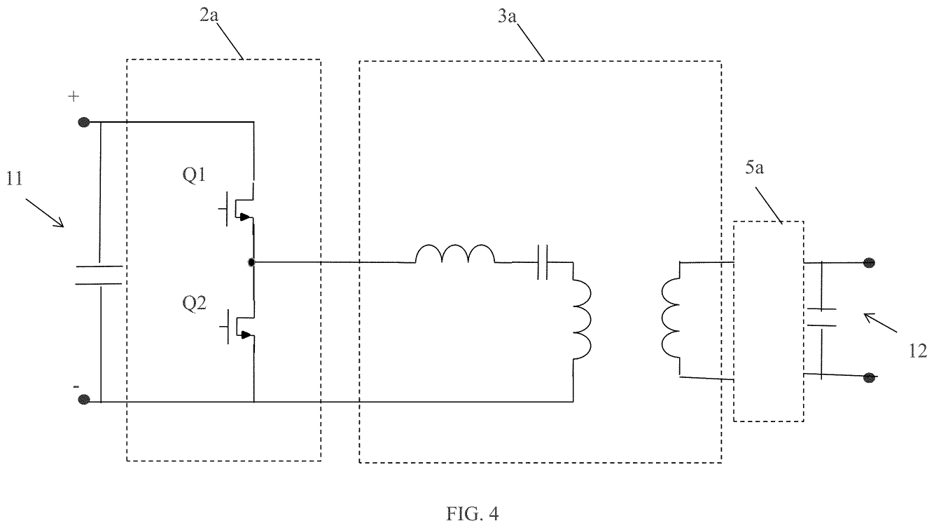

FIG. 4 shows an example of a switch network 2a, resonant tank circuit 3a and output rectifier 5a for an LLC converter. The switch network 2a includes switches Q1 and Q2 that connect the input of the resonant tank circuit 3a to different voltage terminals at different times during a switching period and allow the input of the resonant tank circuit 3a to float for a portion of a switching period. The switching frequency is the frequency at which switches Q1 and Q2 are switched when the resonant power converter is turned on. However, an LLC converter is shown merely by way of illustrating a resonant power converter, as the techniques described herein are not limited to LLC converters.

As shown in FIG. 3A, a controller 4 provides control signals to a gate drive circuit 6 to drive the switch network at a switching frequency f with a sub-modulation duty ratio M. To control the output and/or the input of the resonant power converter 1, the controller 4 controls the switching frequency f and sub-modulation duty ratio M. The controller 4 may control the switching frequency f and sub-modulation duty ratio M using feedback control, feedforward control, both feedback and feedforward control, or any other suitable type of control.

For feedback control, the output (e.g., voltage, current and/or power) of the resonant power converter may be measured and fed back to the controller 4 via a feedback path 13. The controller 4 may compare the output to a setpoint of voltage, current or power and modify the switching frequency f and/or modulation duty ratio M based on the difference between the output and the setpoint.

For feedforward control, the input (e.g., voltage, current and/or power) of the resonant power converter may be measured and fed forward to the controller 4 via a feedforward path 14. Controller 4 may then vary the switching frequency f and/or sub-modulation duty ratio M based on the input. There are a number of different ways in which f and M may be controlled based on feedback and/or feedforward control.

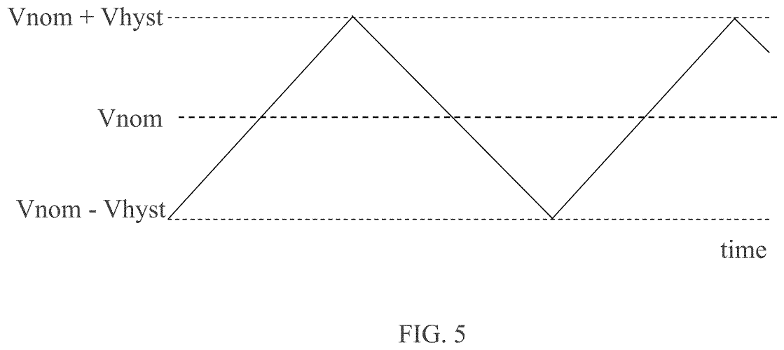

FIG. 3B shows an embodiment in which the sub-modulation duty ratio M is controlled to regulate the output of the resonant power converter 1 and the switching frequency f is controlled based upon the input. To control the output using sub-modulation duty ratio M, the output (voltage, current and/or power) is measured and fed back to the sub-modulation control portion 32 of controller 4 via feedback path 13. The sub-modulation control portion 32 may be a circuit or software module of controller 4, for example. The sub-modulation control portion 32 may compare the measured output with an output setpoint of voltage, current and/or power. For example, if the resonant power converter 1 is designed to produce an output voltage of 5V, the controller 4 may measure the output voltage and compare it to a setpoint of 5V. If the output voltage is too low, the sub-modulation control portion 32 may increase the sub-modulation duty ratio M. If the output voltage is too high, the sub-modulation control portion 32 may decrease the sub-modulation duty ratio M. Any suitable feedback control technique may be used to adjust M, such as proportional control, proportional-integral (PI) control, proportional-integral-derivative (PID) control, or any other suitable type of feedback control. The output may be controlled by modulation of the sub-modulation duty ratio M or by hysteretic control of the sub-modulation duty ratio M. Hysteretic control will be described with reference to FIG. 5.

FIG. 5 illustrates the output (e.g., the output voltage of the resonant power converter 1) when the output is controlled by hysteretic control according to a prior technique described by the assignee of the present application. In hysteretic control, a hysteresis band may be defined that spans a nominal value (e.g., a nominal voltage Vnom). The sub-modulation control portion 32 switches between setting a high value of M (M_high) that causes the output to increase and a low value of M (M_low) that allows the output to decrease. M_high is less than or equal to 1 and greater than M_low. M_low is greater than or equal to 0 and less than M_high. When the output reaches the lower edge of the hysteresis band Vnom−Vhyst, the sub-modulation control portion 32 sets the value of M to M_high to increase the output. When the output reaches the upper edge of the hysteresis band Vnom+Vhyst, the sub-modulation control portion 32 sets the value of M to M_low to allow the output to decrease. As a result, the output may oscillate between the edges of the hysteresis band, as shown in FIG. 5. In some embodiments, the sub-modulation duty ratios may be set so that M_low=0 and M_high=1.

In the embodiment of FIG. 3B, to control the switching frequency f, the input (voltage, current and/or power) may be measured and fed forward to the switching frequency control portion 31 of controller 4 via feedforward path 14. The switching frequency control portion 31 may be a circuit or software module of controller 4, for example. The switching frequency control portion 31 may store a map, such as table or function, that maps various inputs to a corresponding switching frequency. In the case of an LLC converter controlled on the inductive side of its transfer function, if the input decreases, the switching frequency control portion 31 may decrease the switching frequency f to compensate for the decreased input. Conversely, if the input increases, the switching frequency control portion 31 may increase the switching frequency f to compensate for the increased input. Any suitable feedforward technique may be used to control the switching frequency f.

Since the output is controlled by sub-modulation duty ratio M, and the switching frequency only varies in response to the input, the switching frequency f can stay within a narrower range than if switching frequency modulation were used to regulate the output as well as to accommodate varying input voltages.

In the embodiment of FIG. 3C, the control of M and f are flipped, such that switching frequency f is varied to control the output of the power converter, and the sub-modulation duty ratio M is controlled based on the input.

To control the output using switching frequency f, the output (voltage, current and/or power) is measured and fed back to the switching frequency control portion 31 of controller 4 via feedback path 13. The controller 4 may compare the measured output with an output setpoint of voltage, current and/or power. For example, if the resonant power converter 1 is designed to produce an output voltage of 5V, the controller 5 may measure the output voltage and compare it to a setpoint of 5V. In the case of an LLC converter operated on the inductive side of its transfer function, if the output voltage is too low, the switching frequency control portion 31 may decrease the switching frequency f. If the output voltage is too high, the switching frequency control portion 31 may increase the switching frequency f. Any suitable feedback control technique may be used to control f, such as proportional control, proportional-integral (PI) control, proportional-integral-derivative (PID) control, or any other suitable type of feedback control. The output may be controlled by modulation of the switching frequency f or by hysteretic control of the switching frequency f. In hysteretic control, the switching frequency control portion 31 switches between setting a low value of f (f_low) that causes the output to increase and a high value of f (f_high, which is higher than f_low) that allows the output to decrease. With reference to FIG. 5, when the output reaches the lower edge of the hysteresis band Vnom−Vhyst, the switching frequency control portion 31 sets the value of f to f_low to increase the output. When the output reaches the upper edge of the hysteresis band Vnom+Vhyst, the switching frequency control portion 31 sets the value of f to f_high to allow the output to decrease.

Above are described examples in which the control parameters f and M are controlled independently by feedforward and feedback control. However, in some embodiments, f, M or both f and M may be controlled by a combination of feedback and feedforward control, as illustrated in FIG. 3D. FIG. 3D shows that f, M, or both f and M may be controlled by feedback control, feedforward control, or both feedback and feedforward control. FIG. 3E shows that f, M, or both f and M may be controlled by feedback control without the use of feedforward control. FIG. 3F shows that f, M, or both f and M may be controlled by feedforward control without the use of feedback control.

As illustrated in FIG. 3G, in some embodiments the switching frequency f and sub-modulation duty ratio M may be controlled based on each other. The sub-modulation duty ratio may be fed back to the switching frequency control portion 31 to at least partially control switching frequency f. Alternatively or additionally, the switching frequency f may be fed back to the sub-modulation control portion 32 to at least partially control the sub-modulation duty ratio M. Controlling f and/or M based upon each other may be performed in addition to feedback or feedforward control from the output and/or input.

FIG. 3H illustrates that f and M may be controlled by any combination of feedback control from the output, feedforward control from the input, and/or feedback control of the other control parameter M or f. More specifically, f may be controlled based upon any one or more of the following: feedback control from the output, feedforward control from the input, and/or M. M may be controlled based upon any one or more of the following: feedback control from the output, feedforward control from the input, and/or f.

In some embodiments, the controller 4 may store a set of curves or values that maps the measured parameters (e.g., input and/or output parameters) to control parameters for the power converter, such as a switching frequency f and/or sub-modulation duty ratio M. Such curves and/or values may be selected by simulation, theory, or measurement to provide high efficiency at the respective operating parameters. As another example, an operating surface in multiple dimensions (e.g., f and M) may be approximated and the operating points calculated in real time based upon the measured parameters.

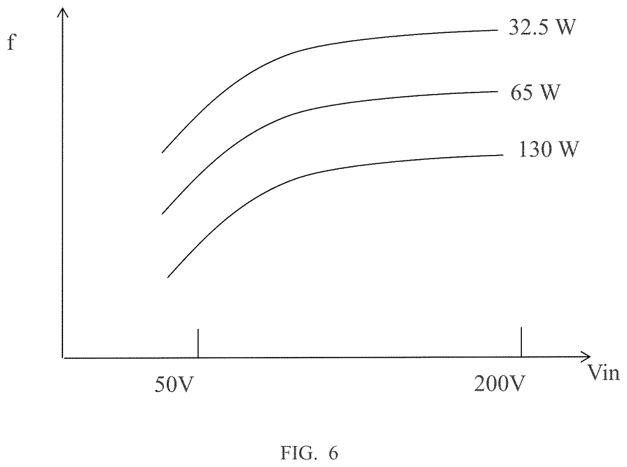

FIG. 3I shows an example in which switching frequency f is controlled using such a mapping. The switching frequency control portion 31 includes a curve selection portion 33 that selects a mapping of input voltage to switching frequency based upon the measured output power. The curve selection performed by curve selection portion 33 is illustrated in FIG. 6. The controller 4 may store a plurality of curves mapping input voltage to switching frequency. The curve selection portion 33 receives the output power measurement and selects the corresponding curve. For example, if the measured output power is 32.5 W, the top curve in FIG. 6 is selected. The selection is provided to the mapping portion 34 of switching frequency control portion 31. The mapping portion 34 receives the measured input voltage and maps the measured input voltage to a switching frequency f based on the selected curve. Controller 4 controls the gate drive circuit 6 based upon the determined switching frequency f.

The term “curve” is used to illustrate the mapping between input voltage and switching frequency. However, any suitable mapping may be used. The mappings may be defined during a design, characterization, and/or manufacturing stage of the resonant power converter and stored by the controller. The controller 4 may store a plurality of mappings for different output powers. Any suitable number of mappings may be stored. Alternatively, the controller 4 may store one or more functions that may be used by the controller 4 to calculate the mappings. In some embodiments, the controller may interpolate between respective mappings (e.g., curves or functions) for measured output powers that fall between the respective mappings. For example, if the controller 4 measures the output power as 50 W, and the controller 4 stores the three curves shown in FIG. 6, the controller 8 may interpolate between the curves corresponding to 32.5 W and 65 W to determine a mapping between them for 50 W.

Another way to determine the switching frequency is for the switching frequency control portion 31 to map both the output power and input voltage to a point on a 3D surface that defines the switching frequency as a function of output power and input voltage. The controller may store the 3D surface as a mapping from output power and input voltage to switching frequencies. The 3D surface may be stored in any suitable way, such as by storing points defining the 3D surface, or by storing a function defining the 3D surface, by way of example. In some embodiments, the controller may interpolate between points on the 3D surface to determine a switching frequency between available values.

Since the most efficient operating point may vary with the output and/or the input of the resonant power converter 1, and two degrees of freedom of control are available, in some embodiments, the sub-modulation duty ratio M and switching frequency f may be selected to control the output using the combination of sub-modulation duty ratio M and switching frequency f that results in the highest efficiency, or an efficiency above a suitable threshold.

In some embodiments, the switching frequency f may be fixed, e.g., at a value selected to maximize efficiency, and sub-modulation duty ratio may be used to control the resonant power converter. If the ability of sub-modulation duty ratio modulation to control the resonant power converter is exceeded, the switching frequency may then be varied as an additional control parameter at one or more extremes of the input and/or output range of the converter. Since very low values of M may produce inefficiencies, the controller 4 may set one or more thresholds, and when the sub-modulation duty ratio M reaches a minimum threshold level, the controller may switch over to frequency modulation as a control technique for the power converter. Such a technique may provide very high efficiency between the extremes of the converter's operating range of inputs and/or outputs.

Control of Duty Ratio and Sub-Modulation Duty Ratio

Embodiments are described above in which a resonant power converter is controlled using feedback control. However, the embodiments described herein are not limited to resonant power converters, as the control techniques described herein may be applied to any type of power converter.

In some embodiments, a power converter is controlled by varying two control parameters: sub-modulation duty ratio M and switching frequency f. In some embodiments, a power converter may be controlled using a combination of sub-modulation duty ratio and another control parameter. For example, some power converters may be controlled by varying the sub-modulation duty ratio M and the duty ratio D.

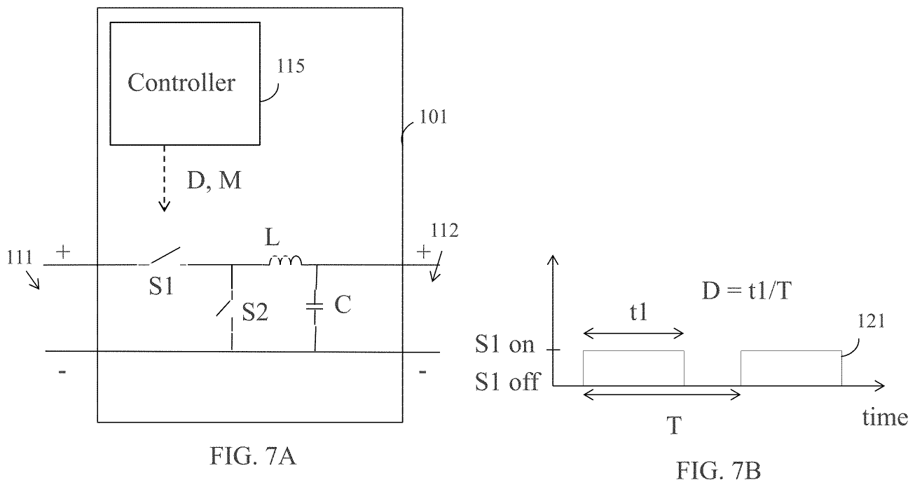

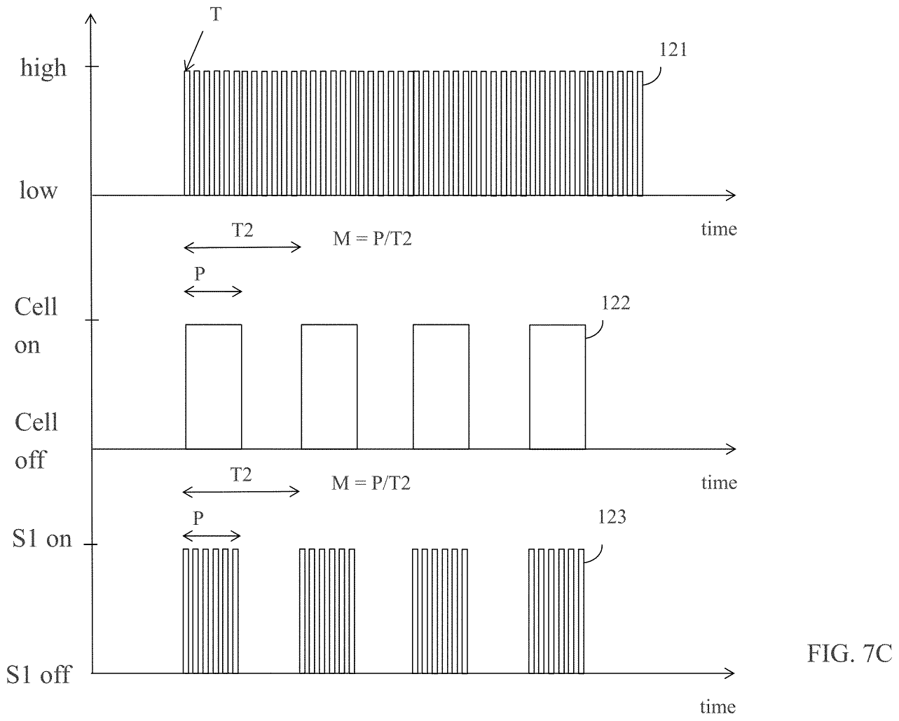

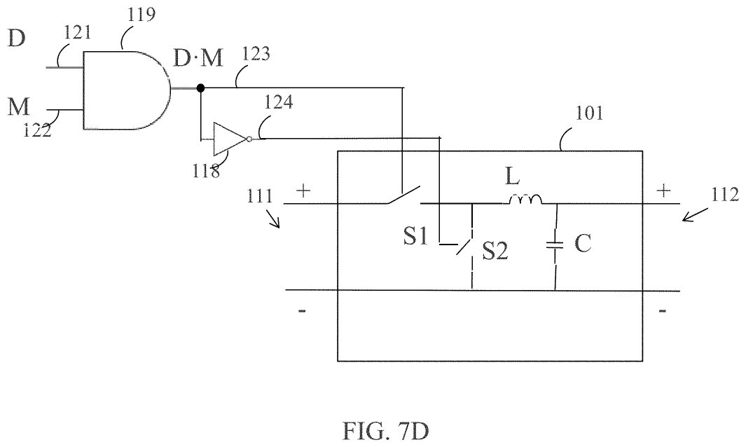

FIG. 7A shows a buck converter as an example of a power converter 101. The buck converter includes a high-side switch S1 and a low-side switch S2. The buck converter switches between turning switch S1 on (with switch S2 off) and turning switch S2 on (with switch S1 off). The fraction of a switching period for which S1 is turned on is the duty ratio D of the power converter 101. The switching of the switches S1 and S2 at a duty ratio D is controlled by a controller 115. Controller 115 may use any suitable control technique to control the power converter 101, such as feedback or feedforward control, for example. Pulse width modulation (PWM) is one suitable control technique, though PWM is only one example of a technique for controlling a power converter based on duty ratio. Regardless of the technique used for controlling the power converter 101, in continuous conduction mode the output voltage (across the output 112) of the buck converter is proportional to the time average of the duty ratio D, which is controlled by controller 115. Switches S1 and S2 produce a square wave voltage that is filtered by the passive elements including inductor L and capacitor C to produce an output voltage proportional to the time average of the duty ratio D. FIG. 7B shows a switching period T in which the switch S1 is turned on by switching control signal 121 for a duration of t1. The duty ratio D is the fraction of the switching period for which S1 is turned on, and is equal to t1/T.

FIG. 7C illustrates sub-modulation of the power converter 101. In FIG. 7C, the entire power converter 101 is turned on and off, or “sub-modulated” at a frequency lower than the switching frequency of the power converter 101. FIG. 7C shows switching control signal 121 on a longer timescale than in FIG. 7B. FIG. 7C also shows a sub-modulation control signal 122 that turns the power converter 101 on and off with a sub-modulation period T2. The power converter 101 is turned on for a period P during the period T2. The fraction of time for which the power converter 101 is turned on termed the “sub-modulation duty ratio,” denoted M, which is equal to P/T2. The output of the power converter 101 can be controlled by controlling the sub-modulation duty ratio M. Increasing the sub-modulation duty ratio M increases the output voltage of the buck converter. Conversely, decreasing the sub-modulation duty ratio M decreases the output voltage of the buck converter. In some embodiments, the duty ratio D of the power converter may be held constant while the sub-modulation duty ratio is changed. In some embodiments, control of both the duty ratio D and the sub-modulation duty ratio M may be performed. In some embodiments, both the duty ratio D and the sub-modulation duty ratio M may be controlled to vary, which can provide two degrees of freedom for control of the power converter 101.

FIG. 7D illustrates circuitry for controlling the switches S1 and S2 based on the duty ratio D and the sub-modulation duty ratio M. The AND gate 119 receives switching signal 121 having a duty ratio D and sub-modulation control signal 122 having a duty ratio M. The AND gate 119 multiplies these signals to produce an output 123 equal to D·M that is high when both D and M are high, and low otherwise. Signal 123 is provided to the control terminal of switch S1 to control switch S1. Switch S2 may be controlled by signal 124 that is complementary to signal 123. An inverter 118 can produce signal 124 based on signal 123. Suitable delay(s) can be introduced to prevent shoot-through (caused by switches S1 and S2 being turned on at the same time). Signal 124 is provided to the control terminal of switch S2 to control switch S2. Control based on M may be disabled by setting M equal to one. However, the circuit of FIG. 7D is provided merely by way of illustration, as it should be appreciated that the control signals for the switches S1 and S2 may be controlled digitally without the use of an AND gate or other logic. In some embodiments, the control signals may be generated by controller 115.

Regardless of the number and type of control parameters used, in general power converters may be controlled using feedback control. In some embodiments, power converters may be designed to be controlled using feedback control under relatively light load and to run open-loop for higher loads.

Control of a Power Converter in an Open-Loop Mode of Operation

Described herein is a power converter module and power converter control technique. In some embodiments, a power converter is controlled using a different control technique in different output load ranges. For relatively low loads, the power converter may be controlled using feedback. For higher loads, the power converter is not controlled using feedback, and instead is allowed to run in an open-loop mode of operation. Such a control technique can allow operating a power converter, such as a resonant power converter, with high efficiency.

Such a technique can be used for any type of power converter, and is not limited to resonant power converters. Further, although an example is described below in which hysteresis-based feedback control is used, the techniques described herein are not limited to hysteresis-based feedback control, as any suitable feedback control technique may be used such as sub-modulation with or without hysteresis, pulse width modulation, frequency modulation, constant on-time control, or constant off-time control, merely by way of example. When the converter runs in the open-loop mode of operation the feedback control may be saturated or otherwise prevented from affecting the operation of the converter. When the converter runs in the open-loop mode of operation it may be uncontrolled, or optionally may be controlled by feedforward control or another technique that does not involve feedback.

In some embodiments that relate to hysteresis-based control, the techniques described herein can improve upon traditional hysteresis-based control to provide high efficiency across a broad load and/or input range for a resonant power converter/system. Such a technique can extend to any converter in which sub-modulation at a frequency lower than the switching frequency of the power switches is used as the dominant control scheme, among other applications.

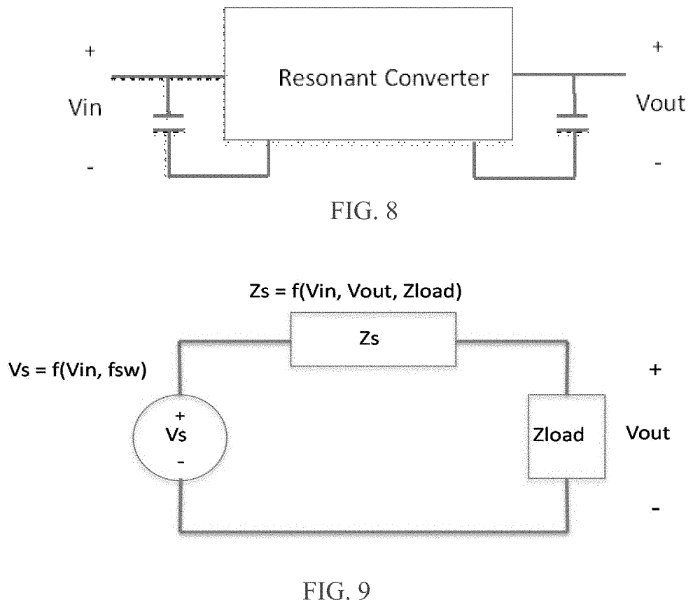

A model of a resonant power converter is shown in FIGS. 8 and 9. A resonant converter is a power conversion system with one or more input voltage terminals and one or more output voltage terminals. For the purposes of this discussion, we will focus on the single input/single output converter as presented in FIG. 8, however, it should be appreciated that the techniques described herein can be extended to multiple input/multiple output converter topologies, as well.

The resonant converter between the input voltage terminal and the output voltage terminal of FIG. 8 comprises a network of switches coupled to a resonant energy storage/transformation network that is operated in such a way as to manifest a desired conversion from Vin->Vout (note that the conversion does not have to be V-V, it could be V-I, I-I, V-P, etc.). As can be appreciated, control circuitry such as controller 4 is provided to control the operation of the switches.

The resonant converter can be modeled as a Thevenin equivalent network, as shown in FIG. 9. The converter is shown as a voltage source (Vs) and a corresponding source impedance (Zs). A load impedance (Zload) is attached across the output terminals of the converter. The output voltage of the converter, Vout, is given by the following relationship:

$${V}_{out} = \frac{{Z}_{load}}{{Z}_{load} + {Z}_{s}} * {V}_{s} \qquad [ 1 ]$$

The equivalent source voltage, Vs, is a complex function of input voltage, Vin, and power device switching frequency, fsw. The source impedance, Zs, is a complex function of input voltage, Vin, output voltage, Vout, and load impedance, Zload.

Vₛ=f(V_{IN},f_{sw}) [2]

Zₛ=f(V_{IN},V_{OUT},Z_{LOAD}) [3]

It is possible to configure the resonant system such that Vs and Zs are functions of different state variables, and it should be appreciated that this disclosure still applies to such converters. Additionally, the model of the converter can be that of a Norton equivalent circuit, where voltage source Vs is replaced by a current source Is, and series source impedance Zs is replaced by a parallel load impedance Zp. Both Is and Zp can be complex functions of various converter state variables. All discussions in this disclosure still apply equally to the Norton model of the system, or any other suitable model.

As discussed above, a resonant converter may be controlled by sub-modulation, which entails turning the converter on and off at a frequency lower than that of the power device switching frequency. Sub-modulation may be performed in such a way as to keep the converter output (e.g., the converter output voltage, current or power) within a particular band, which will be referred to as the regulation band.

A hysteretic control technique may be used to control sub modulation. Such hysteretic control may be performed based on feedback, by sensing the output of the power converter (e.g., the voltage, current or power), and determining based on the sensed output when to turn the converter on or off.

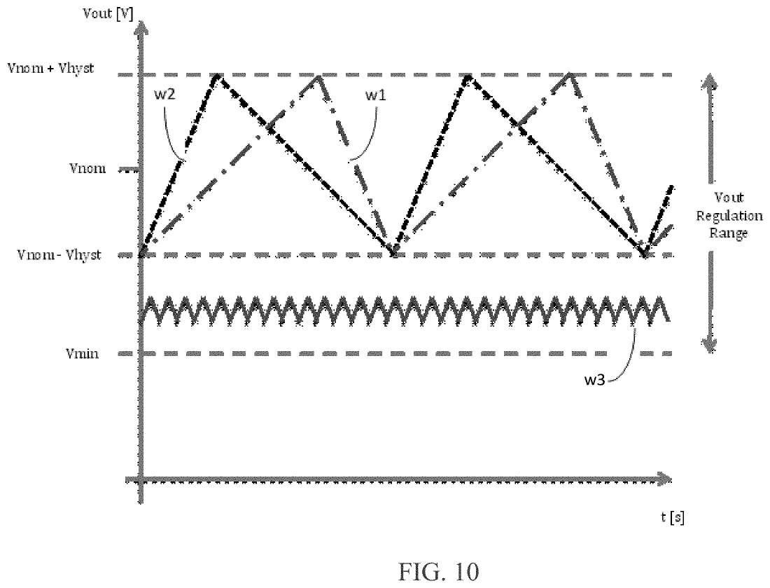

The waveforms w1 and w2 in FIG. 10 illustrate the output voltage produced according to a prior technique of hysteretic sub-modulation, in which the power converter is turned on or off to keep the output within a hysteresis band. Waveform w1 shows the output voltage for a higher load (i.e., lower load resistance, higher output current) as compared to waveform w2, which shows the output voltage for a lower load. When the converter is in the “on state,” energy is delivered to the load, and the output voltage of the converter system increases. When the output voltage reaches a pre-determined upper threshold, defined in this example as Vnom+Vhyst, a control circuit sends a signal to shut down power delivery and changes the converter to the “off state.” Since no more energy is delivered to the load, the output voltage begins to fall. Once the voltage reaches a lower threshold, defined in this example as Vnom−Vhyst, a control circuit sends a signal to re-enable power delivery and changes the converter back to the “on-state.” In so doing, the control circuit can ensure that the output voltage stays within a predefined hysteresis band, quantified in the expression below:

V_{OUT}=V_{OUT,NOM}±V_{hyst} [4]

In order to for equation [4] to be valid, and considering the Thevenin equivalent circuit model presented earlier, a resonant converter should be designed such that the steady state output voltage satisfies the following relation for all anticipated inputs, loads, and switching frequencies.

$$\frac{{Z}_{load}}{{Z}_{load} + {Z}_{s}} * {V}_{s} \geq {V}_{OUT , NOM} + {V}_{hyst} \qquad [ 5 ]$$

The resonant converter can be designed to satisfy this relationship by selecting component values and/other design parameters.

While such a design yields a tight and predictable regulation band, the inventors have recognized and appreciated there exist serious consequences in terms of reduced efficiency. Specifically, the converter is forced into non steady-state operation at the frequency of the sub-modulation. Each time the converter turns off, the resonant network elements lose their steady state energy values, which need to be replenished the next time the converter enters the “on state.” Not only does this result in a measureable amount of energy thrown away every sub-modulation cycle, but the design equations themselves are not valid for a non-negligible period of time at the beginning of an “on state” cycle. This time is referred to as the startup transient. Until the converter enters steady state, which is a function of the time constants of the resonant system in a given converter, the output voltage relationships defined by equations [2] and [3] are invalid, and thus, the power delivery assumptions are themselves invalid.

This reality of hysteretic control leads to the design of resonant systems where the desired power delivery during steady state is the minimum allowable power delivery, thereby ensuring that, across the expected load and input range, the output voltage will always rise when the converter enters the “on state.” Given that the source voltage Vs and source impedance Zs of FIG. 9 present much more current to Zload during the startup transient, excessively large currents and voltages are developed in the resonant network during this time, and a corresponding reduction in efficiency results.

To combat this effect, the converter can be designed to operate in steady state at high/moderate loads, thereby eliminating the deleterious effects of the startup transient. Such a method is particularly important in the moderate-high load range for applications that are thermally limited (e.g., a laptop power adapter), as this is the range where the highest power is dissipated and sets the thermal requirements of the balance of system. By applying this method, improved medium and high power efficiencies are realized, resulting in better performance and a less challenging thermal management problem, which reduces size, weight, and cost.

In some embodiments the Vout regulation range is extended below V_{OUT,NOM}−V_{hyst} to a value termed V_{MIN}, as can be seen in FIG. 10. This value is outside the traditional hysteretic control range as defined by vnom+/−vhyst, and in a place where a traditional hysteretic monitoring circuit would instruct the converter to stay permanently in the “on state.” Without need for additional control intelligence/complexity, the network can be designed such that Vs, which is a function of Vin and fsw (see equation [2]), and Zs, which is a function of Vin, Vout, and Zload (see equation [3]), naturally shift in magnitude such that the resultant Vout drops below V_{OUT,NOM}−V_{hyst} at loads greater than some value. This transitional load can be represented as Z_{TRAN}:

V_{OUT,NOM}+V_{hyst}≥V_{OUT}≥V_{OUT,NOM}−V_{hyst}; for ∞≥|Z_{LOAD}|≥|Z_{TRAN}| [6]

V_{OUT,NOM}−V_{hyst}≥V_{OUT}≥V_{MIN}; for |Z_{TRAN}|≥|Z_{LOAD}|≥|Z_{MIN}| [7]

As can be seen from equations [6] and [7], there is a broad range of loads for which the converter operates in the “on state” indefinitely. This scenario is represented by waveform w3 in FIG. 10. There are no “modulation” events that drive the converter out of steady state, and thus, maximum efficiency over a broad range of loads can be achieved with this method.

It should be appreciated that additional complexity, in the form of feed forward or feedback, can be employed to actively modify the functions that define Vs and Zs, so as to further increase the load or input range over which the converter does not modulate. At some light load level, the hysteretic monitoring circuit will ensure that V_{OUT,MAX} does not exceed V_{OUT,NOM}+V_{HYST}, as in traditional hysteretic control, but at higher load levels, and over a very broad range, the converter can be made to operate exclusively in steady state while ensuring that Vout,nom+Vhyst≥V_{OUT}≥V_{MIN}. This method of regulation can also be applied where the desired variable to be regulated is a current, voltage, power, or any function that is a combination of one or more of these terms.

It should also be appreciated that the functions defining Vs and Zs can be programmed into the system, via analog or digital means, at design, manufacturing, system test, or any other stage, given that Vs and Zs can be manipulated via a multi-dimensional mapping between power device switching frequency, input voltage, output voltage, and output load.

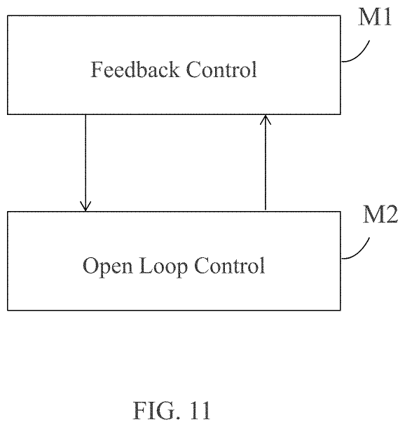

An example will be described to illustrate switching between feedback control and open-loop control. FIG. 11 shows a flowchart illustrating control of a power converter in two different control modes: M1 and M2.

In control mode M1, the power converter is controlled using feedback. Control mode M1 may be used at relatively low power levels. In some embodiments, the feedback control employed may control sub-modulation of the power converter based on feedback from the output. However, any suitable type of feedback may be used, such as pulse width modulation, frequency modulation, constant on-time control, or constant off-time control, merely by way of example. If the feedback control employs sub-modulation, the sub-modulation may be controlled with our without hysteresis, as discussed above. In some embodiments, control mode M1 may include use of a control technique in addition to feedback control. For example, control mode M1 may also include performing feedforward control based on the input to the power converter.

In control mode M2, the feedback control employed in control mode M1 is stopped, and the power converter may be allowed to run open-loop. In some cases, the feedback control may be stopped due to saturation of the feedback control. For example, if the feedback control includes sub-modulation with hysteresis, if the load is high enough the feedback control will be saturated, such that the power converter is controlled to stay turned on. At high enough loads the power converter remains in control mode M2 indefinitely, which leads to high efficiency due to avoidance of sub-modulation. The output (e.g., output voltage) of the power converter is allowed to fall into a range below the hysteresis band. The output voltage may vary up or down as the load varies, or may remain constant. The power converter stays in control mode M2 until the load becomes so light that the output voltage reaches the top edge of the hysteresis band, at which point the sub-modulation of control mode M1 resumes, and the power converter is turned off. The power converter remains off until the output drops to the bottom edge of the hysteresis band, at which point the power converter re-enters control mode M1.

Control mode M2 optionally may include performing feedback control based on the input, as discussed above. Such a technique may account for variations in the input voltage.

As a specific example for a resonant power converter, control mode M1 may include performing sub-modulation with hysteresis based on feedback from the output of the power converter and feedforward control by varying switching frequency of the power converter based on the input, as discussed above. However, this is merely by way of example.

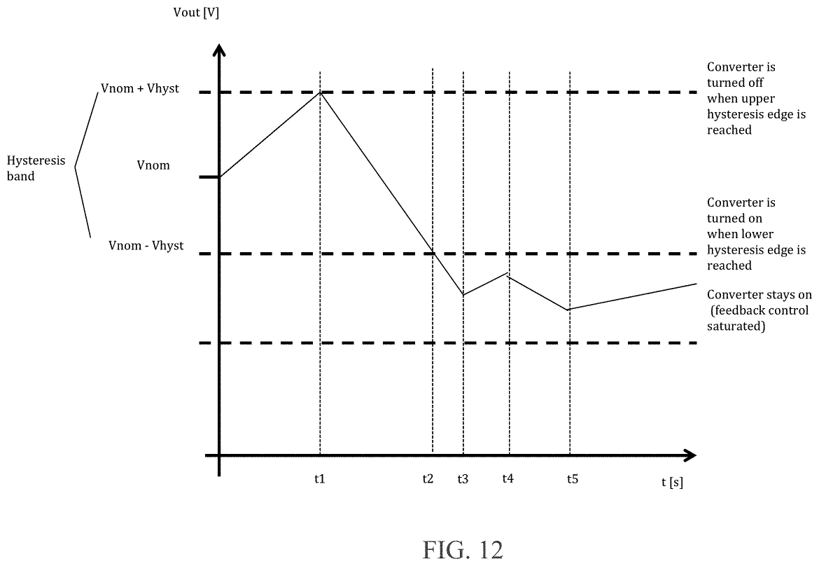

FIG. 12 shows an exemplary waveform of the output voltage of the power converter vs. time. Initially, the power converter may be turned on as the output voltage rises. When the output voltage reaches the top of the hysteresis band at time t1, the power converter turns off. At this point, the power converter is controlled in control mode M1. The output voltage then falls as the load draws current. If the load is high enough, the output voltage will reach the lower edge of the hysteresis band at time t2. At that point the controller turns on the power converter and enters control mode M2. If the load continues to increase the output voltage may fall below the hysteresis band. At time t3 the load decreases, and the output voltage rises, but power converter stays in control mode M2. At time t4 the load increases and the output voltage falls. At t5, the load decreases and the output voltage increases again. During these variations in the load, the power converter stays in control mode M2, with the power converter turned on, running open-loop. The power converter will stay in control mode M2 until the load lightens to the point where the output voltage reaches the upper edge of the hysteresis band.

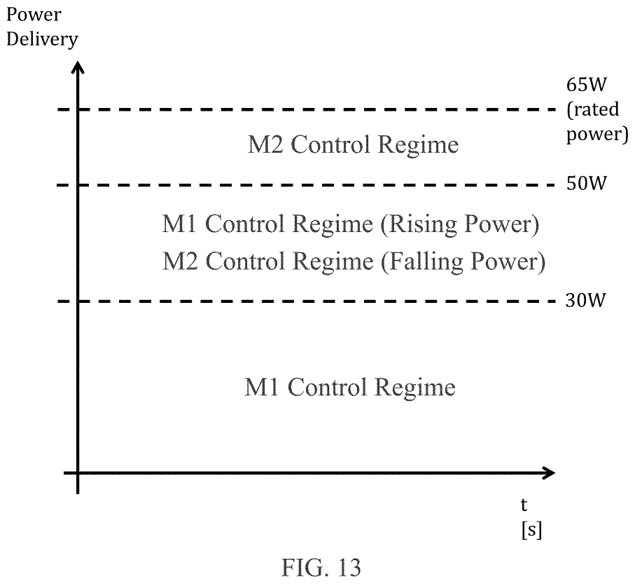

FIG. 13 shows which control mode applies in different regimes of power delivery. As discussed above, control mode M1 applies at relatively low power levels and control mode M2 applies at relatively high power levels. For example, when supplying loads below 40 or 50% of the rated power of the power converter, the power converter may stay in control mode M1. At loads above 70 or 80% of the rated power, the power converter may stay in control mode M2. FIG. 13 illustrates an example in which the rated power of the power converter is 65 W. The controller is in control mode M1 when it is delivering less than 30 W, and in control mode M2 when it is delivering more than 50 W. At intermediate power levels the power converter may be in control mode M1 or M2 depending on whether the output is rising or falling. If the power converter is in the light load (M1 control) regime and the load increases the power converter may stay in control mode M1 until the load reaches 50 W, at which point the power converter enters control mode M2. However, if the power converter is in the high load (M2 control) regime and the load decreases below 50 W the power converter may stay in control mode M2 until the load decreases to 30 W, at which point the power converter enters control mode M1. Thus, there is hysteresis as to which control mode the power converter is in at intermediate levels of power delivery, which depends on the previous level of power delivery.

Comparison to “Burst Mode” Control

A prior technique exists to address low efficiency that occurred in light load conditions. Such a technique is termed “burst mode” control. Rather than having a power converter stay turned on all the time at light load, which lead to very inefficient operation, burst mode control was developed. Essentially, rather than keeping the power converter turned on in very light loads, the power converter would be turned off for some number of cycles, which was essentially a “sleep mode.” The power converter would wake back up after a certain number of cycles and turn on if necessary. Such converters were controlled using feedback control, a technique which did not change at increasing load levels.

AC Line Input Prediction/Estimation and Power Estimation

This section relates to techniques and apparatus by which one can use information contained in the input voltage waveform of a power converter to improve the behavior of a power converter to produce higher efficiency, improved voltage regulation, and higher supply rejection. Such techniques can be employed on any converter, resonant or otherwise, that is connected to the AC mains, or other predictable, or periodically varying input voltage, and is applicable to AC->DC, AC->AC, or any other conversion paradigm.

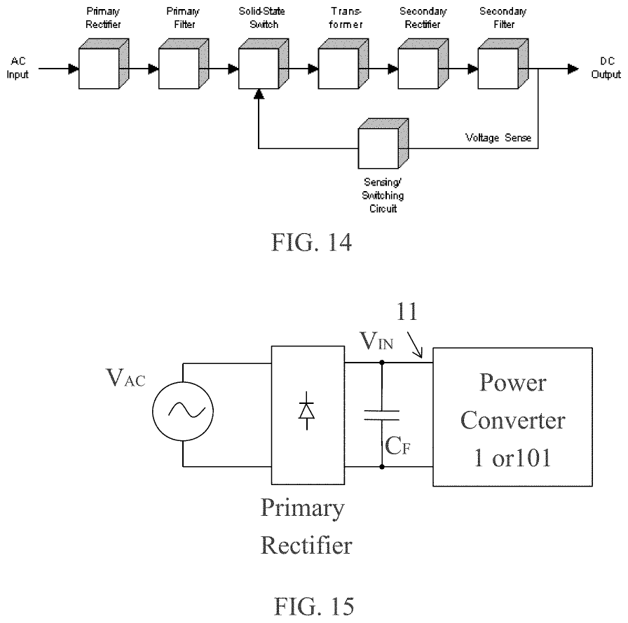

FIG. 14 shows a model of an AC mains connected power supply. Here, one can see the AC mains connected through a rectifier and a filter to a network of solid-state switches. These switches present a modified AC waveform to an isolation stage (represented above as a transformer), which is then rectified and filtered again to result in a DC output voltage. A sensing circuit monitors that DC output voltage, and feeds back information to the primary side of the converter to affect control. In this canonical system implementation, input and output disturbance rejection relies entirely on the bandwidth of the feedback network.

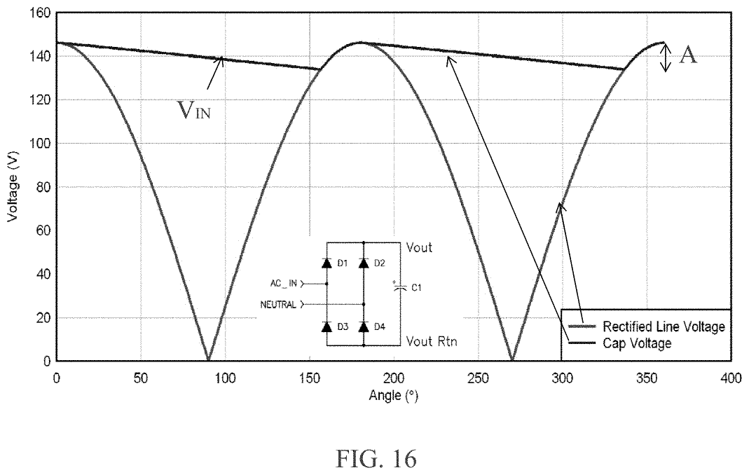

FIG. 15 shows a diagram of a primary rectifier connected to the AC line, which provides a voltage VAC to the primary rectifier. At the output of the rectifier is a primary filter, which is realized by a capacitor C_{F}, in this example. The voltage across the capacitor is provided to the power converter 1 or 101 at input port 11. The inset in FIG. 16 shows an example of an implementation of the primary rectifier and primary filter. It should be appreciated that there are other circuit implementations of the primary rectifier and primary filter blocks, and the circuit in FIG. 16 just one of these implementations.

The primary rectifier and filter do not produce a constant output voltage, as illustrated in FIG. 16. The top waveform in FIG. 16 shows the voltage across the capacitor C_{F}, and the bottom waveform shows a rectified version of voltage VAC. When the rectified voltage falls, the voltage across the capacitor C_{F} falls slowly at a rate that may be constant for relatively low loads on the converter. When the rectified voltages rises again to the point where it is equal to the voltage across the capacitor C_{F}, the voltage across the capacitor C_{F} will remain equal to the rectified voltage for the duration of the rising portion of the waveform. It should be appreciated that the line voltage VAC is periodic at the frequency of the line, which is relatively constant (e.g., at about 50 or 60 Hz).

As discussed in a prior section, it can be advantageous to use feedforward control to modify the operation of the power converter 1 or 101 to compensate for variations in the input (e.g., the input voltage V_{IN}). This can be accomplished for a resonant converter by modifying switching frequency or another control parameter based on the input (e.g., the input voltage V_{IN}). To effect such control, the input voltage V_{IN} can be measured using a sensor. However, the inventors have recognized and appreciated that there is a delay in the sensing of the input voltage of the power converter due to the transfer function of the sensor. If the input voltage of the converter changes slowly, this sensor delay may not cause an issue. However, if the input voltage V_{IN} is changing quickly enough, the sensed input voltage may be significantly different from the actual input voltage V_{IN}. For example, on the rising edge of V_{IN} may change quickly, as shown in FIG. 16. Due to the delay in sensing V_{IN}, the voltage reported to the controller of the power converter may be lower than the actual voltage Ver. As a result, the controller may not adequately compensate for Ver. As a result, the output voltage of the power converter may drop and/or the power converter may operate less efficiently. The techniques described in this section allow providing a more accurate estimate of V_{IN} on the rising and/or falling portion of the waveform, which enables the control of the power converter to be improved.

The variation of the input voltage V_{IN} waveform shown in FIG. 16 may be viewed as a disturbance to the power conversion system. Corrective action can be taken to improve regulation of the controlled output variable, which in this example is output voltage, though any other output variable can be controlled.

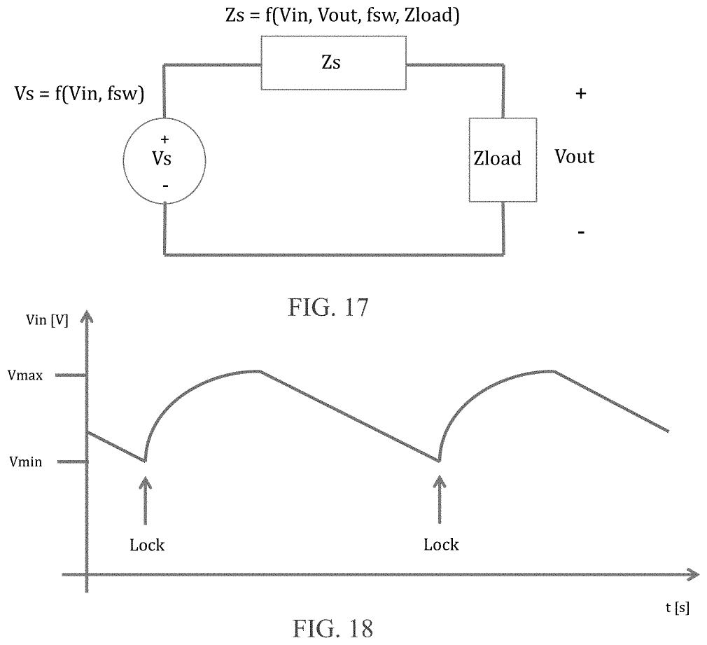

To understand the corrective action to be taken, it is helpful to present a simplified model of a resonant power converter. In most power conversion topologies, the sinusoidal input frequency is much slower than the converter switching frequency. Therefore, on the time scale of the input frequency, the input voltage is essentially constant. This assumption allows the simplified model of FIG. 17 to be used. FIG. 17 shows a Thevenin equivalent network particularly suited to resonant converters, that treats the power converter as a source of a fixed amplitude, Vs, in series with an impedance, Zs.

In FIG. 17, resonant converter 1 is modeled as a voltage source (Vs) and a corresponding source impedance (Zs). A load impedance (Zload) is attached across the output terminals of the converter. The output voltage of the converter, Vout, is then given by the following relationship:

$${V}_{out} = \frac{{Z}_{load}}{{Z}_{load} + {Z}_{s}} * {V}_{s} \qquad [ 1 ]$$

In this model, the equivalent source voltage, Vs, is a complex function of input voltage, Vin, and power device switching frequency, fsw. Additionally, the source impedance, Zs, is a complex function of, Vin, fsw, output voltage, Vout, and load impedance, Zload.

Vₛ=f(V_{IN},f_{sw}) [2]

Zₛ=f(V_{IN},V_{OUT},f_{SW},Z_{LOAD}) [3]

It is possible to configure the converter system such that Vs and Zs are functions of different state variables, such as solid-state switch duty cycle, and it should be appreciated that this disclosure still applies to those converter instances. Additionally, the model of the converter can be that of a Norton equivalent circuit, where voltage source Vs is replaced by a current source Is, and series source impedance Zs is replaced by a parallel load impedance Zp. Both Is and Zp can be complex functions of various converter state variables. All discussions in this disclosure still apply to the Norton model of the system.

Given that the elements of equation [1] are functions of converter input voltage, it can be seen that as the input voltage of the converter changes, so will the output voltage. This is a disturbance, in the presence of which the control circuitry of a power converter can take corrective action to maintain the expected output voltage. Such action may include, but is not limited to, a change in switching frequency, a shift in solid-state switch duty cycle, or a combination of both.

Considering once again the V_{IN} waveform of FIG. 16, under moderate to heavy load, there are portions of the waveform that experience high rates of change, where the effective frequency components of the input signal exceed that of the fundamental frequency of the sinusoid. These high frequency components impose a minimum bandwidth on the converter control system in order to achieve good regulation of the output.

These high bandwidth requirements place heavy burdens on traditional feedback control systems. A feed-forward technique may be applied concert with feedback to effect an increase in apparent bandwidth and improve disturbance rejection. In the case of input disturbances, information about the instantaneous input voltage can be used to augment the operation of a given converter. Such augmentation can be a change in switching frequency, duty cycle, or any other system variable, where the system variable becomes a function of the converter input voltage.

As mentioned above, to take action based upon input voltage, or any other input signal incident upon the converter, a circuit network needs to sense the input voltage (or other input signal). Most circuit networks introduce delay (“phase” in circuit vernacular) into measurements, and as such, the benefit of the feed-forward information path can be greatly diminished. In some cases the measurement phase can degrade system performance to a greater extent than if the feed-forward path did not exist in the first place.

Described herein is a technique for compensating for the effect of measurement phase error in a feed-forward information path for sensing the input voltage of a converter. This disclosure focuses on the input voltage characteristic as shown in FIG. 16 (rectified AC mains), but it should be appreciated that the same technique can apply to a multitude of input configurations where the voltage varies in a predictable (e.g., periodic) manner.

FIG. 18 shows an exemplary waveform for V_{IN}. FIG. 18 shows that in addition to sensing the input voltage waveform, a technique is used to lock onto the input voltage waveform to establish a time (phase) reference. FIG. 18 illustrates an example in which the controller locks onto the valleys (Vmin) of the waveform. However, the controller can lock onto any portion of the waveform, such as the peak of the waveform, for example. Any suitable analog or digital circuitry can be used to lock onto the waveform, such as a phase-locked loop (PLL, analog or digital), a delay-locked loop (DLL, analog or digital) or a valley detector (analog or digital), for example. By locking onto a periodic point in the waveform, a time or phase reference is established that can aid in compensating for the measurement delay.

Once the system is locked, techniques for counteracting the sensing delay can be employed. For instance, if the system locks to the valley of the input voltage, the controller can assume that the region of high slew rate, and thus high input frequency content, is about to occur. Specific corrective action, in the form of feed-forward state variable augmentation, can be employed to counteract the impending high frequency disturbance.

In some embodiments, the controller may adjust the converter behavior based on a continuously updated model of the inputs. As an example, the model may be updated based on new input parameters each line cycle. Since a PLL is used to lock the model to the actual line, the sensing delay is removed or otherwise reduced, and the controller can better accommodate the high frequency disturbances. If the input changes (e.g., the phase of the input drifts, or the amplitude changes) the model parameters will be adjusted according to the sensor inputs. In the case of the AC mains, the frequency is generally very stable, thus locking onto the waveform provides good performance.

Producing a good estimate of V_{IN} is especially important for converters that employ hysteretic modulators for output voltage control. The aim with this type of control is to keep the converter output voltage within a particular band, which will be referred to as the regulation band. A circuit exists to sense when the output voltage has reached the high end of the band (Vout,nom+Vhyst) and to turn the converter off. The same circuit senses when the output voltage has fallen to the low end of the band (Vout,nom−Vhyst) and re-enables the converter. The resulting output voltage of the converter can be expressed as:

V_{OUT}=V_{OUT,NOM}±V_{hyst} [4]

In order to for equation [4] to be valid, and considering the Thevenin equivalent circuit model shown in FIG. 17, a converter should be designed such that the steady state output voltage satisfies the following relation for all inputs, loads, and switching frequencies of interest:

$$\frac{{Z}_{load}}{{Z}_{load} + {Z}_{s}} * {V}_{s} \geq {V}_{OUT , NOM} + {V}_{hyst} \qquad [ 5 ]$$

Without the use of the locking and prediction/estimation techniques described herein the magnitude of Vs and Zs will be far outside the design range during the high slew rate periods of the input voltage waveform. Delay introduced by the input sensing and processing network will yield improper settings for the functions presented in equations [2] and [3], and thus, the performance of the converter will be outside the expected range. These performance differences can manifest in many ways, most notably in degraded efficiency, as the converter may deliver far more instantaneous power than designed while experiencing the effects of the input sensing delays, resulting in exceedingly high RMS currents in the power conversion network. Additionally, output voltage regulation can suffer, as the values expected in equation [1] are no longer valid. It should be appreciated that the deleterious effects are not limited to the two just mentioned, and that any design specification can suffer from the lack of proper input voltage tracking.

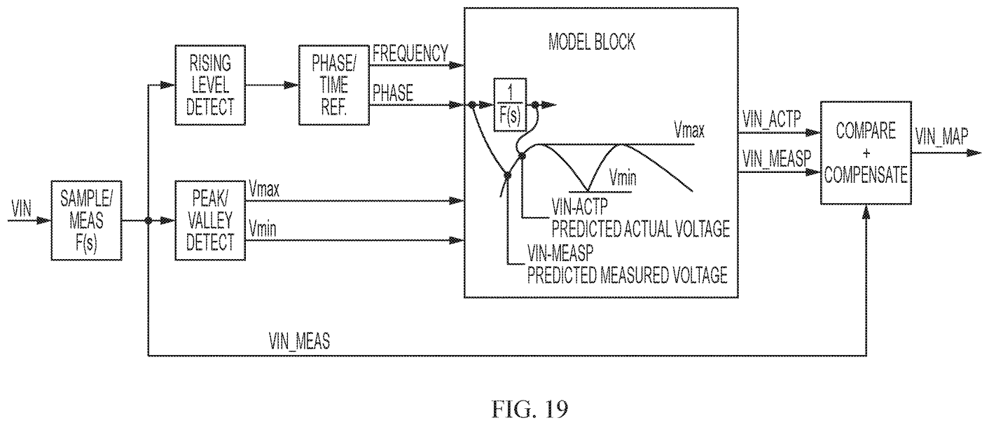

FIG. 19 shows a block diagram of a technique for compensating for the transfer function of the sensor in the feed-forward path. The first block in the diagram “Sample/Meas”, represents the measurement and sampling subsystem, also termed a “sensor” for brevity. The sensor has a frequency-dependent response termed “F(s).” The sensor measures V_{IN} and generates the measured voltage, V_{IN_meas}, which will have an inherent offset from the actual value of V_{IN} according to the frequency content of V_{IN}—this is the difference sought to be compensated. V_{IN_meas} is fed into a level detector (“Rising Level Detect”), which generates an output each time V_{IN_meas} crosses a threshold voltage level, in the rising direction. The unidirectional constraint ensures that one measurement will be provided per line cycle. This output is fed into the “Phase/Time Reference” block which generates the reference signals, “Phase” and “freq,” the phase and frequency of V_{IN}. These are used in the “Model Block.” The “Peak/Valley” detect block extracts the maximum voltage Vmax and minimum voltage Vmax of V_{IN}, and provides these values to the Model Block. With the values Vmax and Vmin, and freq and phase, and knowing expected shape of the curve, the model block creates a reference value model of Vin. For example, as illustrated in FIG. 18, since the shape of the curve is known, the minimum, maximum, phase and frequency are known, a model curve for V_{IN} can be created. It then uses the phase reference to determine the predicted value of Vmeas, “V_{IN}_measp.” It also implements an inverse function of the sampling/measurement delay to predict where the actual value of V_{IN}, “Vin_actp,” which will be higher on the rising slope and lower on the falling slope. Vin_measp and Vin_actp are fed into the compare and compensate block were Vin_meas is compared with Vin_measp. If these values are approximately equal, then Vin_actp is fed out as Vin_map. If Vin_meas and Vin_measp differ, the value of Vin_actp is adjusted (up if Vin_meas is greater than Vin_measp and down in the opposite case) before being fed out as Vin_map. Vin_map is then used to drive the voltage-to-frequency map that is used in the converter to establish the correct instantaneous cell power.

Any suitable sensor may be used. As mentioned above, the transfer function of the sensor, the inverse of the transfer function, or other information indicative of the phase delay introduced by the sensor may be stored in memory of the power converter. The remaining functional blocks shown in FIG. 19 may be implemented by analog circuitry, digital circuitry and or a controller (e.g., controller 5 or 115) using hardware or a combination of hardware and software. The functional blocks shown in FIG. 19 are merely illustrative, and not meant to be limiting. For example, rather than having a separate level detector could be implemented as one of the outputs of the peak or valley detector.

Another factor to take into account is that as the power conversion load increases at the output of the converter system of FIG. 17, the amplitude A of the V_{IN} waveform increases. FIG. 16 shows the amplitude A. The converter 1 or 101 acts as a loading impedance across filter capacitor C_{F}, and as the converter output load increases, the effective load impedance decreases, causing larger excursions in capacitor voltage between the sinusoidal peaks of the AC mains input. As discussed further below, this is compensated for by combining the measurement used to generate the feed-forward signal with the phase determined by the PLL.

In the extreme, where the load is sufficiently high, the V_{IN} waveform will approach the shape of the rectified sinusoid, though practical designs rarely enter this regime as the large excursions tend to decrease overall system efficiency and increase peak stresses

Some embodiments of the techniques described herein relate to determining converter load based on the amplitude of the input voltage V_{IN}. As was previously discussed, the magnitude of the variation in the input voltage V_{IN} is affected by the load demanded at the output. By detecting the maximum and minimum values of the input waveform, as seen in FIG. 18, and having knowledge of various component values in the system, a controller can make a prediction/estimation as to the value of the load. In some embodiments, one can use the load prediction as a stand-alone system, separate from the techniques described herein for estimating V_{IN}. Using input voltage to sense output load can eliminate the need for a dedicated load sensor in the converter system, and thus, reduce the cost and complexity of the control circuits.

With reference to FIG. 18, the power P at the input port 11 of the converter can be calculated as follows. The difference between the minimum and maximum voltage of V_{IN} can be used (in conjunction with the line period or frequency) to determine the average power over the line cycle that the converter is demanding at its input (the actual power delivered to the load is the converter input power minus the power dissipated). This power is useful to have in many scenarios, and may be used implicitly in the prediction system for the input. It can be used explicitly, such as in cases where there is a desire to limit the peak forward power (say in short circuit or overload protection), and other optimizations (such as choosing different voltage-frequency maps based on the average forward power).

There are at least two equations representing equivalent ways to determine the average power.

To derive the first equation, we compute power from the relationship: dV/dt=P/(VC), where dV/dt is the slope of the capacitor C_{F} voltage with time, P is the power at the input port 11 of the converter, Vmax and Vmin are the maximum and minimum voltages of the capacitor C_{F} during a line cycle, and C is the capacitance of the capacitor C_{F}. Solving for power we get: P=(C(Vmax−Vmin)Vmin)/t. All that is left is to compute t, the time when the line rectifier turns on and begins re-charging the capacitor, which is the denominator. This can be calculated using algebra and trigonometry to result in the following equation, where T is the line period.

$$P = \frac{CV min ( V max - V min )}{\frac{T}{4} + \frac{T}{2 π} {sin}^{- 1} \frac{V min}{V max}}$$

Another way to calculate the power is to use the energy difference between the peak charge on the capacitor and the minimum charge on the capacitor C_{F} (E=0.5C*V\hat{ }2) and multiply by twice the line frequency, f. The following equation gives the power P, where ΔV is the difference between Vmax and Vmin, and fline is the frequency of the AC line.

P=CΔV·Vmin·fline

By measuring the peak capacitor voltage, the minimum capacitor voltage, and having the period/frequency information available, it is possible to approximately determine the cycle-by-cycle power drawn by the converter. Such calculations may be performed by controller 4 or 115 for example. The result may be used in any suitable way. As an example, such a calculation may be used as a safety mechanism. The estimated power is compared to a safety threshold, and if the safety threshold is exceed the power converter can be shut down.

Information regarding the power drawn by the converter can alternatively or additionally be used for the estimation of V_{IN}, as described above.

Additional Aspects

In the power converters described herein, it should be appreciated that input and/or output filters may be included. The input or output filters may take the form of a capacitor in parallel with the input or output, by way of example.

The controllers described herein may be implemented by circuitry such as electronic circuits or a programmed processor (i.e., a computing device), such as a microprocessor, or any combination thereof.

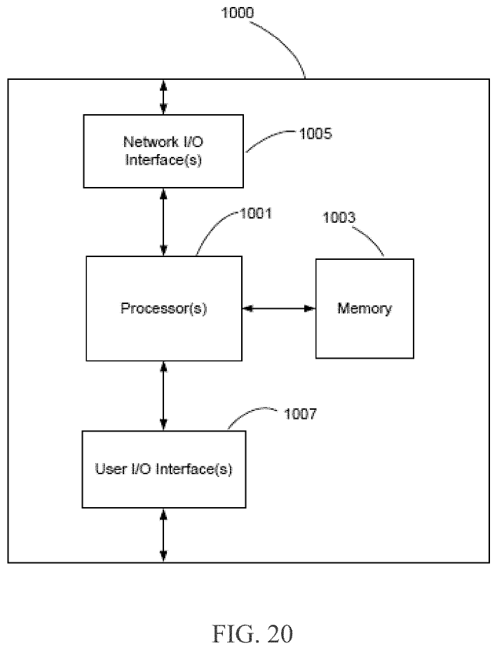

FIG. 20 is a block diagram of an illustrative computing device 1000 that may be used to implement any of the above-described techniques. Computing device 1000 may include one or more processors 1001 and one or more tangible, non-transitory computer-readable storage media (e.g., memory 1003). Memory 1003 may store, in a tangible non-transitory computer-recordable medium, computer program instructions that, when executed, implement any of the above-described functionality. Processor(s) 1001 may be coupled to memory 1003 and may execute such computer program instructions to cause the functionality to be realized and performed.

Computing device 1000 may also include a network input/output (I/O) interface 1005 via which the computing device may communicate with other computing devices (e.g., over a network), and may also include one or more user I/O interfaces 1007, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. For example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-discussed functions of one or more embodiments. The computer-readable medium may be transportable such that the program stored thereon can be loaded onto any computing device to implement aspects of the techniques discussed herein. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A power module, comprising:
a power converter having a controller configured to control the power converter, the controller being configured to control the power converter using feedback for a first load on the power converter, and to allow the power converter to operate without controlling the power converter using the feedback for second load on the power converter higher than the first load.

2.-4. (canceled)

5. A power module, comprising:
a power converter having a controller configured to control the power converter, the controller being configured to control the power converter using feedback when an output of the power converter is within a first range, and to allow the power converter to operate without controlling the power converter using the feedback when the output of the power converter is below the first range.

6.-8. (canceled)

9. The power module of claim 5, wherein the power converter is a resonant power converter.

10. The power module of claim 5, wherein the power converter operates with feedforward control when the output of the power converter is within or below the first range.

11. The power module of claim 5, wherein the control with feedback is performed using hysteresis.

12. The power module of claim 11, wherein control with feedback using hysteresis includes varying sub-modulation based on the feedback.

13. The power module of claim 12 wherein varying the sub-modulation based on the feedback comprises turning off the power converter when an output of the power converter reaches an upper boundary of a hysteresis band and turning on the power converter when the output of the power converter reaches a lower boundary of the hysteresis band.

14. The power module of claim 13, wherein the power converter is controlled to stay on when the output of the power converter is below the lower boundary of the hysteresis band.

15. A power module, comprising:
a power converter having a controller configured to control the power converter, the controller being configured to
i) when an output of the power converter is within a first range, control the power converter using feedback to sub-modulate the power converter with hysteresis, such that the power converter is turned off when an output of the power converter reaches an upper edge of a hysteresis band and the power converter is turned on when the output reaches a lower edge of the hysteresis band; and
ii) allow the power converter to operate without the feedback when the output falls below the lower edge of the hysteresis band.

16. (canceled)

17. The power module of claim 15, wherein ii) includes controlling the power converter using feedforward control.

18. The power module of claim 15, wherein i) includes controlling the power converter using feedforward control.

19. The power module of claim 15, wherein i) is performed for loads exceeding a first threshold level and ii) is performed for loads below a second threshold level.

20.-37. (canceled)

38. The power module of claim 1, wherein the power converter is a resonant power converter.

39. The power module of claim 1, wherein the power converter operates with feedforward control when an output of the power converter is within or below a first range.

40. The power module of claim 1, wherein the control with feedback is performed using hysteresis.

41. The power module of claim 40, wherein control with feedback using hysteresis includes varying sub-modulation based on the feedback.

42. The power module of claim 41, wherein varying the sub-modulation based on the feedback comprises turning off the power converter when an output of the power converter reaches an upper boundary of a hysteresis band and turning on the power converter when the output of the power converter reaches a lower boundary of the hysteresis band.

43. The power module of claim 42, wherein the power converter is controlled to stay on when the output of the power converter is below the lower boundary of the hysteresis band.
